(19) United States
(12) Patent Application Publication
(10) Pub. No.: US 2026/0250491 A1
(43) Pub. Date: Aug. 27, 2026

(54) Masterbatch Compositions and Their Use

(71) Applicant: Milliken & Company, Spartanburg, SC (US)

(72) Inventors: Philip Adetunji, Doncaster (AU); Brian Egan, Altona (AU)

(21) Appl. No.: 18/854,539

(22) PCT Filed: Apr. 6, 2023
(86) PCT No.: PCT/AU2023/050279

§ 371 Date: Oct. 6, 2024

(30) Foreign Application Priority Data
Apr. 6, 2022 (AU) 2022900898
Mar. 24, 2023 (AU) 2023900832
Mar. 24, 2023 (AU) 2023900833

(51) Int. Cl. C08L 23/06; C08J 5/18; C08K 5/00; C08K 5/092

(52) U.S. Cl. CPC C08L 23/06; C08J 5/18; C08K 5/0083; C08K 5/092; C08J 2323/06; C08L 2203/16; C08L 2205/025; C08L 2207/062; C08L 2310/00

(57) ABSTRACT

The present disclosure relates broadly to high barrier polyolefin compositions and masterbatch compositions comprising a synergistic combination of a nucleating agent and a hydrocarbon resin and use thereof for preparing barrier layers and films having barrier properties suitable for packaging applications.

### TECHNICAL FIELD

The present disclosure relates broadly to high barrier polyolefin compositions and masterbatch compositions for preparing barrier layers and films having barrier properties suitable for packaging applications. Particular embodiments disclosed herein relate to masterbatch compositions and their use for forming a high barrier polyolefin layer in a film.

### CROSS REFERENCE TO RELATED APPLICATIONS

This application claims priority to Australian Provisional Patent Application No. 2022900898 filed 6 Apr. 2022, Australian Provisional Patent Application No. 2023900832 filed on 24 Mar. 2023, and Australian Provisional Patent Application No. 2023900833 filed on 24 Mar. 2023, each of which is incorporated herein by cross-reference in its entirety as if set forth in full.

### BACKGROUND

Polyolefins, such as polyethylene, high density polyethylene (HDPE), low density polyethylene (LDPE), linear low density polyethylene (LLDPE), metallocene linear low density polyethylene (mLLDPE), very low density linear polyethylene (VLLDPE), ethylene-vinyl acetate (EVA) and plastomers have a variety of commercial uses.

Polyethylene is a versatile polymer with a combination of unique properties such as chemical inertness, toughness, low permeability to water vapour and oxygen, and mouldability.

High Density Polyethylene (HDPE) is commonly used in blown film applications where high resistance to water vapour and oxygen transmission is beneficial, such as, for example, cereal box liners and packaging for dry foods.

Water vapour transmission rate (WVTR) and oxygen transmission rate (OTR) are important properties of barrier films. These properties reflect the amount of water vapour and oxygen that can pass through a film, respectively. Generally, for films used in many food packages, it is desirable for the films to exhibit low values of WVTR and/or OTR.

The best-in-class HDPE blown film grades have a water vapour transmission rate (WVTR) in the range of about 3.0-3.6 g/m²/day at 40 micron gauge. As WVTR is also a function of film thickness, this translates to about 2.4-2.9 g/m²/day at 50 micron gauge.

The WVTR at a particular gauge is a property that correlates not only with the intrinsic properties of the HDPE, but also how it was processed into film. The addition of hydrocarbon resin (HCR) mixed into polyolefins, such as polypropylene and polyethylene, has been used to improve barrier resistance. It is generally taught and accepted in the prior art that relatively high concentrations of HCR of at least about 10%-20% w/w are required to achieve a suitable WVTR performance, i.e., about 30% decrease in WVTR, in a typical film. For example, EP 2520615, WO 2010/104628 and US 2012/0107542 disclose that concentrations of HCR greater than 10% w/w, are necessary to afford the desired barrier and mechanical properties in the barrier layers exemplified therein. As the cost of HCR is relatively high, the inclusion of high concentrations of HCR in barrier films adds significantly to overall production cost. It would therefore be advantageous and desirable if suitable barrier properties could be achieved using less HCR. Furthermore, high concentrations of HCR (e.g., concentrations of above 10% w/w) can considerably degrade useful film mechanical properties such as toughness and tear resistance, and can adversely affect the suitability of films for use in packaging or contacting food.

In contrast to WVTR, processibility is a property intrinsic to the material/resin and not the film. Poor processibility not only provides difficulty in making blown film from the resin, but the film mechanical properties, such as tear strength and puncture resistance, can also be adversely impacted.

Nucleating agents facilitate the formation of crystals readily and widely during processing. The net outcome is smaller crystals, which when well dispersed culminate in a more torturous path for gas molecules through the resin. When a typical HDPE film is effectively nucleated, the WVTR can be reduced by about 25% to about 30%. However, there are difficulties associated with effectively introducing and homogenising nucleating agents into HDPE.

One approach to improve the effectiveness of nucleation involves narrowing the molecular weight distribution of the polymer and limiting the extent of long chain branching. By changing the molecular weight distribution in the polymer such that very low molecular weight fractions are blended in a particular ratio with high molecular weight fractions, the capacity of the resin for effective nucleation can be improved so that the WVTR can be decreased in the order of 40%-50%. In another approach, blends of HDPE polymers having low and high melt flow indexes and a nucleating agent have been shown to be effective at lowering WVTR by about 20%-40%. However, there is a limit to how much the barrier properties can be improved by the addition of higher melt index or low molecular weight polymer without adversely impacting the processibility and the film mechanical properties, in particular puncture and tear resistance. It would be advantageous and desirable if suitable processability, mechanical properties and barrier properties could be achieved using a wider specification of the film components, such as lower melt index and broader molecular weight ranges of the polymer.

There have been a number of other approaches to improve the water vapour barrier of HDPE-based films. For example, a layer of HDPE can be laminated or co-extruded with other layer materials to form a multi-layer HDPE-based film with improved water vapour barrier properties. However, the formation of multi-layer films typically involves higher cost and such films are generally less recyclable. In particular, the use of different types of materials in multi-layer films can limit the ability to recycle the films, with consequential adverse environmental impacts. Monolayer films of HDPE can also be prepared and the water vapour barrier of monolayer films can be improved by increasing its thickness, but this has the significant disadvantage of adding weight and cost to packages formed with these films.

There is a need for barrier films having suitable barrier properties, such as high resistance to water vapour and oxygen transmission balanced with robust film properties. There is also a need for barrier films having suitable barrier properties using lower amounts of HCR and a wider specification of component polymers.

### SUMMARY

The present invention relates generally to films having improved barrier properties, and methods for preparing such films.

Embodiments of the invention disclosed herein relate to masterbatch compositions comprising a nucleating agent, a hydrocarbon resin, or both a nucleating agent and a hydrocarbon resin, and a polyolefin, preferably polyethylene, more preferably high density polyethylene (HDPE), as well as the use of such masterbatch compositions to prepare a high barrier polyolefin (HBP) layer, e.g., a HBP barrier layer in a film. Other embodiments disclosed herein relate to the use of masterbatch technology to prepare a high barrier polyolefin (HBP) composition, and use of the HBP composition to prepare a high barrier polyolefin (HBP) layer in a high density polyethylene film.

In preferred embodiments, the polyolefin is selected from the group consisting of polyethylene, high density polyethylene (HDPE), low density polyethylene (LDPE), linear low density polyethylene (LLDPE), metallocene linear low density polyethylene (mLLDPE), very low density linear polyethylene (VLLDPE), ethylene-vinyl acetate (EVA) and plastomers, more preferably high density polyethylene (HDPE).

In a first aspect, the present invention relates to a high barrier polyolefin composition comprising:
a nucleating agent in an amount of from about 0.01% to about 1% w/w,
a hydrocarbon resin in an amount of from about 0.1% to about 10% w/w,
optionally one or more additive components, and
a polyethylene.

Preferably, the polyethylene is HDPE.

Preferably, the polyethylene, e.g., HDPE is present in an amount not less than 90% w/w. In other embodiments, the polyethylene, e.g., HDPE, is present in an amount not less than 95% w/w, or not less than 98% w/w.

In some embodiments, the high barrier polyolefin composition comprises:
a nucleating agent in an amount of from about 0.01% to about 1% w/w,
a hydrocarbon resin in an amount of from about 0.1% to about 5% w/w,
optionally one or more additive components, and
a polyethylene.

Preferably, the high barrier polyolefin composition is a homogeneous composition. Preferably, the homogeneity is effected by dynamic melt mixing, shear and extensional mixing effected via techniques such as twin-screw compounding, or two roll milling, and the like.

In a second aspect, the present invention relates to a masterbatch comprising a nucleating agent, a hydrocarbon resin and a polyethylene, wherein:
the nucleating agent is present in the masterbatch in an amount of from about 0.2% to about 15% w/w;
the hydrocarbon resin is present in the masterbatch in an amount of from about 2.5% to about 80% w/w; and
the polyethylene is present in the masterbatch in an amount greater than about 5% w/w,
   when used to form a high barrier polyolefin composition comprising:
the nucleating agent in an amount of from about 0.01% to about 1% w/w; and
the hydrocarbon resin in an amount of from about 0.1% to about 10% w/w.

In some embodiments, the nucleating agent is present in the masterbatch in an amount of from about 1% to about 25% w/w, or about 2.5% to about 25% w/w; the hydrocarbon resin is present in the masterbatch in an amount of from about 25% to about 55% w/w; and the polyethylene is present in the masterbatch in an amount greater than about 20% w/w.

In a third aspect, the present invention relates to a masterbatch comprising a synergistic combination of a nucleating agent and a hydrocarbon resin; and a polyethylene.

In a fourth aspect, the present invention relates to a masterbatch comprising a nucleating agent, a hydrocarbon resin and a polyethylene, wherein:
the nucleating agent is present in the masterbatch in an amount of from about 0.2% to about 15% w/w, about 1% to about 25% w/w, or about 2.5% to about 25% w/w;
the hydrocarbon resin is present in the masterbatch in an amount of from about 2.5% to about 80% w/w, or about 25% to about 55% w/w; and
the polyethylene is present in the masterbatch in an amount greater than about 20% w/w.

In a fifth aspect, the present invention relates to a kit comprising a nucleating agent masterbatch and a hydrocarbon resin masterbatch, wherein:
the nucleating agent is present in the nucleating agent masterbatch in an amount of from about 0.1% to about 30% w/w; and
the hydrocarbon resin is present in the hydrocarbon resin masterbatch in an amount of from about 5% to about 80% w/w,
   when used to form a high barrier polyolefin composition comprising:
the nucleating agent in an amount of from about 0.01% to about 1% w/w; and
the hydrocarbon resin in an amount of from about 0.1% to about 10% w/w,
wherein the nucleating agent masterbatch and the hydrocarbon resin masterbatch are used in a ratio of about 5:1 to about 1:60.

In a sixth aspect, the present invention relates to a kit comprising a nucleating agent masterbatch and a hydrocarbon resin or hydrocarbon resin masterbatch, wherein:
the nucleating agent is present in the nucleating agent masterbatch in an amount of from about 0.1% to about 30% w/w; and
the hydrocarbon resin is present in the hydrocarbon resin masterbatch in an amount of from about 5% to about 80% w/w.

In some embodiments, the nucleating agent is present in the nucleating agent masterbatch in an amount of from about 2.5% to about 25% w/w; and the hydrocarbon resin is present in the hydrocarbon resin masterbatch in an amount of from about 25% to about 55% w/w.

In some embodiments, the nucleating agent is present in the nucleating agent masterbatch in an amount of from about 5% to about 25% w/w; and the hydrocarbon resin is present in the hydrocarbon resin masterbatch in an amount of from about 25% to about 55% w/w.

In some embodiments, the ratio of the nucleating agent masterbatch to the hydrocarbon resin masterbatch is from about 5:1 to about 1:60.

In a seventh aspect, the present invention relates to a kit comprising a nucleating agent and a hydrocarbon resin masterbatch, wherein:
the hydrocarbon resin is present in the hydrocarbon resin masterbatch in an amount of from about 5% to about 80% w/w,
   when used to form a high barrier polyolefin composition comprising:
the nucleating agent in an amount of from about 0.01% to about 1% w/w; and
the hydrocarbon resin in an amount of from about 0.1% to about 10% w/w.

In a preferred embodiment of the seventh aspect of the invention, the nucleating agent is admixed with a polyolefin. Preferably, the polyolefin is polyethylene.

In preferred embodiments of the high barrier polyolefin composition, the HBP masterbatch, or the kits disclosed herein, the nucleating agent and hydrocarbon resin are present in a ratio from about 1:4 to about 1:200. Preferably, the nucleating agent and hydrocarbon resin are present in a ratio of about 1:10 to about 1:100. Preferably the nucleating agent and hydrocarbon resin are present in a ratio of about 1:10 to about 1:50.

In preferred embodiments of the high barrier polyolefin compositions, the HBP masterbatch, the HCR masterbatch or the kit disclosed herein, the hydrocarbon resin has a weight average molecular weight of no more than about 10,000 Daltons. Preferably, the hydrocarbon resin is derived from a crude olefin feed selected from the group consisting of C5 olefin feed streams, C9 olefin feed streams, terpene olefins, pure monomers, and a combination thereof. In preferred embodiments, the hydrocarbon resin is a hydrogenated hydrocarbon resin. In other preferred embodiments, the hydrocarbon resin is a cyclic olefin copolymer.

In preferred embodiments of the high barrier polyolefin compositions, the HBP masterbatch, the NA masterbatch, or the kits disclosed herein, the nucleating agent may be an organic compound or an inorganic compound. Preferably, the nucleating agent comprises a metal salt. Preferably, the nucleating agent comprises a salt of a branched alkyl phosphonic acid, a hydrophthalic acid metal salt, a bicycloheptane dicarboxylic acid metal salt, or a combination thereof. In one embodiment, the hydrophthalic acid metal salt is a hexahydrophthalic acid metal salt or a heptahydrophthalic acid metal salt. Preferably, the nucleating agent comprises a hexahydrophthalic acid metal salt.

In some embodiments, the polyethylene is HDPE. In some embodiments, the HDPE has a density of from about 0.94 to about 0.97 g/cm³. In some embodiments, the HDPE has a melt flow index of from about 0.08 to 40.0 g/10 min, preferably from about 0.08 to 10.0 g/10 min.

In an eighth aspect, the present invention relates to the use of a HBP masterbatch of the invention comprising a nucleating agent and a hydrocarbon resin to form a high barrier polyolefin (HBP) composition, wherein the ratio of the nucleating agent to hydrocarbon resin in the high barrier polyolefin composition is the same or substantially the same as the ratio of nucleating agent to hydrocarbon resin in the masterbatch.

In a ninth aspect, the present invention relates to the use of a kit of the invention to form a high barrier polyolefin composition, wherein the ratio of the nucleating agent to hydrocarbon resin in the high barrier polyolefin composition is the same or substantially the same as the ratio of nucleating agent to hydrocarbon resin in the kit.

In a tenth aspect, the present invention relates to a barrier layer which is:
formed from the high barrier polyolefin composition of the invention; or
formed by blending a masterbatch of the invention comprising a nucleating agent and hydrocarbon resin with bulk HDPE; or
formed by blending the components of a kit of the invention with bulk HDPE.

In one or more embodiments, the NA MB, HCR MB, HBP MB, HBP composition or barrier layer may comprise one or more additive components. Representative examples of additives include antioxidants (including primary and secondary antioxidants), antacid metal salts, fire retardants, lubricants, UV stabilizers, antistatic agents, processing aids, and the like. If desired, such additives may be added to the extruder and melt compounded into the relevant masterbatch or HBP composition.

In some embodiments, the bulk HDPE has a density of from about 0.94 to about 0.97 g/cm³. In some embodiments, the bulk HDPE has a melt flow index of from about 0.08 to 40.0 g/10 min, preferably from about 0.08 to 10.0 g/10 min.

In an eleventh aspect, the present invention relates to a film comprising the barrier layer of the invention, wherein the film has a water vapour transmission rate (WVTR), as measured by ASTM F 1249-20, which is reduced by at least about 10% relative to a film of equivalent thickness which does not comprise the barrier layer of the invention.

In a twelfth aspect, the present invention relates to a method of reducing the water vapour transmission rate (WVTR) of a film, the method comprising incorporating the barrier layer of the invention into the film, wherein the film has a WVTR, as measured by ASTM F 1249-20, which is reduced by at least about 10% relative to a film of equivalent thickness which does not have the barrier layer of the invention.

In some embodiments of the invention disclosed herein, the nucleating agent is present in the nucleating agent masterbatch or HBP masterbatch in an amount of from about 0.1% to about 30% w/w, or about 0.2% to about 25% w/w, or about 0.3% to about 25% w/w, or about 0.2% to about 15% w/w, or about 0.3% to about 20% w/w, or about 0.3% to about 15% w/w, or about 0.5% to about 20% w/w, or about 0.5% to about 15%, or about 0.5% to about 10% w/w.

In some embodiments of the invention disclosed herein, the hydrocarbon resin is present in the hydrocarbon resin masterbatch or HBP masterbatch in an amount of from about 5% to about 80% w/w, or about 2.5% to about 70% w/w, or about 2.5% to about 60% w/w, or about 10% to about 70% w/w, or about 20% to about 60% w/w, or about 5% to about 50% w/w, or about 7.5% to about 45% w/w, or about 10% to about 40% w/w, or about 30% to about 50% w/w.

In some embodiments of the invention disclosed herein, the nucleating agent and hydrocarbon resin are present in the HBP masterbatch, or HBP composition, or the barrier layer in a ratio of about 1:4 to about 1:200, preferably about 1:7 to about 1:150, more preferably about 1:10 to about 1:100, even more preferably about 1:15 to about 1:50.

In some embodiments of the invention disclosed herein, the polyethylene is present in the masterbatch in an amount greater than about 5%, preferably in an amount greater than about 10% w/w, preferably in an amount greater than about 15% w/w, preferably in an amount greater than about 20% w/w, preferably in an amount greater than about 25%, more preferably from about 30% to about 50% w/w.

Other embodiments of the present invention disclosed herein relate to the use of a HBP masterbatch of the invention comprising a nucleating agent and hydrocarbon resin to form a barrier layer in a film. In a preferred embodiment, the HBP masterbatch is blended with bulk HDPE to form a barrier layer in a film.

The present invention further relates to a barrier layer produced by blending bulk HDPE and the HBP masterbatch of the invention comprising a nucleating agent and hydrocarbon resin

The present invention further relates to a barrier layer produced by blending bulk HDPE with a synergistic combination of a nucleating agent in a nucleating agent masterbatch and a hydrocarbon resin in a hydrocarbon resin masterbatch.

In preferred embodiments, the nucleating agent is present in the barrier layer in an amount of from about 0.01% to about 1% w/w, preferably about 0.02% to about 0.7% w/w, preferably about 0.03% to about 0.5% w/w, preferably about 0.03% to about 0.2% w/w, or preferably about 0.05% to about 0.2% w/w.

In preferred embodiments the hydrocarbon resin is present in the barrier layer in an amount of from about 0.1% to about 10% w/w, preferably about 0.2% to about 9% w/w, preferably about 0.3% to about 8% w/w, preferably about 0.5% to about 7% w/w, preferably about 0.5% to about 6% w/w, preferably about 0.5% to about 5% w/w, preferably about 0.5% to about 4% w/w, preferably about 0.7% to about 3% w/w, or preferably about 1% to about 2% w/w.

In some embodiments of the aspects above, the hydrocarbon resin has a weight average molecular weight of no more than about 10,000 Daltons, preferably no more than about 5,000 Daltons, more preferably no more than about 2,000 Daltons, even more preferably no more than about 1,000 Daltons, most preferably wherein the hydrocarbon resin has a weight average molecular weight of about 400 to about 800 Daltons.

In some embodiments of the invention disclosed herein, the hydrocarbon resin is derived from crude olefin feed selected from the group consisting of C5 olefin feed streams, C9 olefin feed streams, terpene olefins, pure monomers, and a combination thereof. Preferably, the hydrocarbon resin is a hydrogenated hydrocarbon resin or a cyclic olefin copolymer.

In some embodiments of the invention disclosed herein, the nucleating agent comprises a metal salt. Preferably, the nucleating agent comprises a salt of a branched alkyl phosphonic acid, a hydrophthalic acid metal salt, a bicycloheptane dicarboxylic acid metal salt, or a combination thereof. In one embodiment, the hydrophthalic acid metal salt is a hexahydrophthalic acid metal salt or a heptahydrophthalic acid metal salt. Preferably, the nucleating agent comprises a hexahydrophthalic acid metal salt.

In some embodiments of the invention disclosed herein, the HDPE has a density of from about 0.94 to about 0.97 g/cm³, preferably about 0.95 to about 0.965 g/cm³.

In some embodiments of the invention disclosed herein, the bulk HDPE has a density of from about 0.94 to about 0.97 g/cm³, preferably about 0.95 to about 0.965 g/cm³.

In other embodiments, the present invention disclosed herein relate to a film comprising the barrier layer of the invention disclosed herein. In preferred embodiments the film has a water vapour transmission rate, as measured by ASTM F 1249-20, which is reduced by at least about 10%, about 15%, about 20%, about 25%, about 30%, about 35%, about 40%, about 45%, about 50%, about 55%, about 60%, about 65%, about 70%, about 75%, or about 80%, relative to a film of equivalent thickness which does not have the barrier layer of the invention. In some embodiments, the film is a multilayer or monolayer film.

Other embodiments of the present invention disclosed herein relate to a method of reducing the water vapour transmission rate of a film, the method comprising incorporating the barrier layer of the invention into the film, wherein the film has a water vapour transmission rate, as measured by ASTM F 1249-20, which is reduced by at least about 10%, about 15%, about 20%, about 25%, about 30%, about 35%, about 40%, about 45%, about 50%, about 55%, about 60%, about 65%, about 70%, about 75%, or about 80%, relative to a film of equivalent thickness which does not have the barrier layer of the invention. In some embodiments, the film is a multilayer or monolayer film.

### BRIEF DESCRIPTION OF THE FIGURES

FIG. 1 is a graph showing water vapour transmission rates (WVTR), normalised for thickness, for films in accordance with embodiments of the present invention, as well as comparative films produced using alternative methods—as described in Table 1.

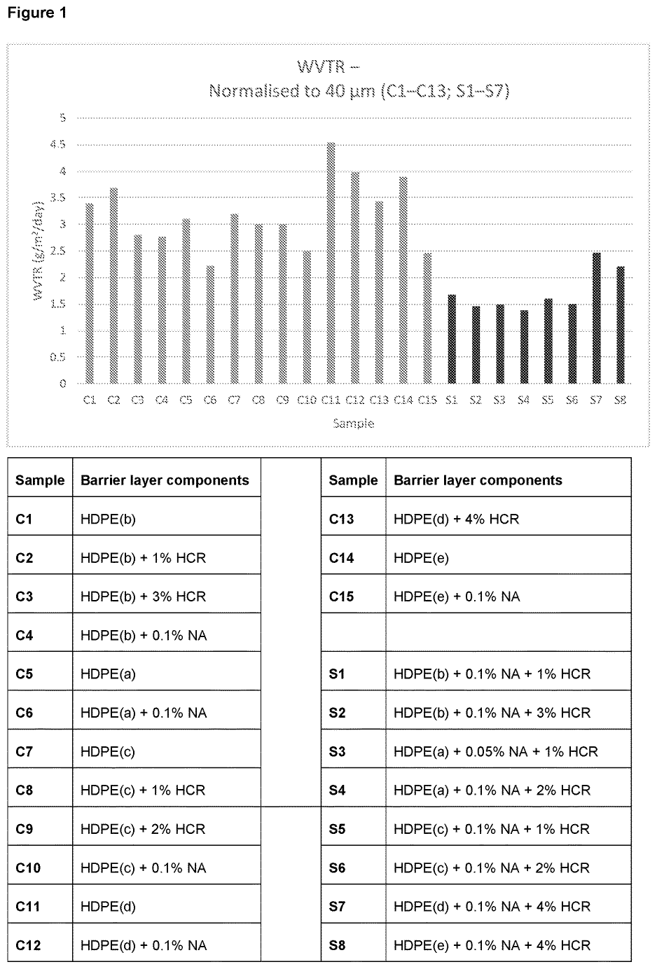

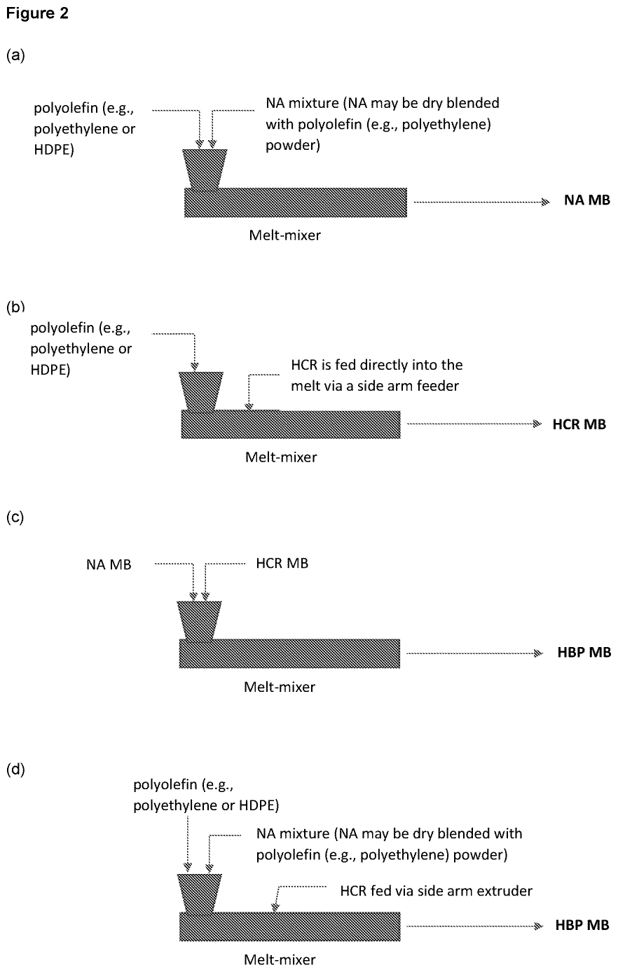

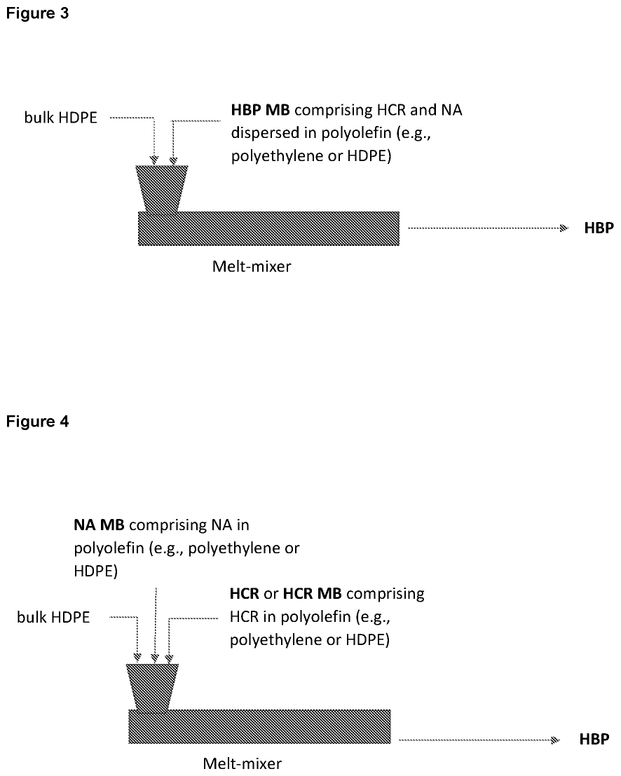

FIG. 2 shows schematic diagrams of non-limiting embodiments of the present invention:
(a) the use of a melt-mixer to blend polyolefin and nucleating agent (NA) mixture to produce a nucleating agent masterbatch (NA MB);
(b) the use of a melt-mixer to blend polyolefin and hydrocarbon resin (HCR) to produce a hydrocarbon resin masterbatch (HCR MB);
(c) the use of a melt-mixer to blend the NA MB of FIG. 2(a) and the HCR MB of FIG. 2(b) to produce a high barrier polyolefin masterbatch (HBP MB).
(d) the use of a melt-mixer to blend NA mixture, HCR and polyolefin to produce a high barrier polyolefin masterbatch (HBP MB).

FIG. 3 is a schematic diagram of an embodiment of the present invention in which a melt-mixer is used to blend HBP MB and bulk HDPE to produce a high barrier polyolefin (HBP) composition.

FIG. 4 is a schematic diagram of an embodiment of the present invention in which a melt-mixer is used to blend the NA MB, the HCR or HCR MB and bulk HDPE to produce a HBP composition suitable for forming a barrier layer.

### DETAILED DESCRIPTION

### Definitions

As used herein, the singular forms ‘a’, ‘an’, and ‘the’ designate both the singular and the plural, unless expressly stated to designate the singular only.

As used herein the term ‘about’ and the use of ranges in general, whether or not qualified by the term about, means that the number comprehended is not limited to the exact number set forth herein, and is intended to refer to values substantially within the quoted range while not departing from the scope of the invention. As used herein, ‘about’ will be understood by persons of ordinary skill in the art to allow for small or non-substantial variations reflecting the appropriate level of precision according to the context in which it is used. If there are uses of the term which are not clear to persons of ordinary skill in the art given the context in which it is used, ‘about’ will mean up to plus or minus 10% of the particular term.

The term ‘barrier’ as used herein with reference to a material such as a layer, indicates that the material controls the permeation of one or more molecules or compounds, which may be gaseous, vapour or liquid, including but not limited to oxygen and water vapour.

As used herein the terms ‘comprises’, ‘comprising’, ‘includes’, ‘including’, or similar terms are intended to mean a non-exclusive inclusion, such that a method, process, system, product, composition or apparatus that comprises a list of integers does not include those integers solely, but may also include other integers not listed.

As used herein the term ‘consisting of’ is an exclusive term and means consisting only of.

As used herein the term ‘consisting essentially of’ means that integers other than those listed may be included that do not materially alter or influence the properties or function of the method, process, system, product, composition or apparatus.

All percentages (%) referred to herein are percentages by weight (w/w), unless otherwise indicated.

Polymer molecular weights referred to herein are weight average molecular weight (MW), unless otherwise indicated.

As used herein the term ‘masterbatch’ refers to a concentrate or premix composition of a particular additive or mixture of additives in which components are dispersed (preferably to achieve a substantially homogenous dispersion) within a carrier material. In the context of the present specification the carrier material is a polyolefin.

As used herein the term ‘polyolefin’ refers to polymers of olefin monomers. The polyolefin may be a homopolymer or a copolymer. A ‘homopolymer’ polyolefin refers to a polymer that consists substantially (i.e., at least 90% by weight, preferably at least 95% by weight, more preferably at least 97% by weight) of an olefin and thus a homopolymer preferably predominately comprises said olefin. A ‘copolymer’ polyolefin refers to a polymer that is formed from the copolymerisation of one olefin and at least one other olefin. Non-limiting examples of polyolefins include polyethylene, high density polyethylene (HDPE), low density polyethylene (LDPE), linear low density polyethylene (LLDPE), metallocene linear low density polyethylene (mLLDPE), very low density linear polyethylene (VLLDPE), ethylene-vinyl acetate (EVA) and plastomers.

As used herein the term ‘bulk high density polyethylene’ (‘bulk HDPE’) refers to the HDPE that the masterbatch composition(s) are mixed into to form the HBP composition.

As used herein the term ‘HBP composition’ comprises nucleating agent and hydrocarbon resin and refers to the mixture produced when bulk HDPE is blended or mixed with the HBP masterbatch, or the nucleating masterbatch and hydrocarbon resin masterbatch compositions.

As used herein, the term ‘film’ may refer to a substantially planar material of any thickness. In some embodiments, a film as described herein can be a substantially planar material having an average thickness of no more than about 500 μm, e.g., from about 10 μm to about 500 μm, preferably from about 20 μm to about 200 μm, or from about 25 μm to about 100 μm, or from about 30 μm to about 80 μm, or from about 35 μm to about 70 μm, or from about 40 μm to about 60 μm. Films of the invention can be monolayer or multilayer films, for example, in the form of a substantially planar sheet or web. Films of the invention in the form of non-planar arrangements or shapes are also contemplated, for example, the film may comprise a layer or layers in an article which is formed by a moulding process, such as blow moulding or injection moulding. The injection moulding may be used for preparing parts and casings such as caulking guns and sealant cartridges, and the blow moulding of containers such as bottles.

As used herein, the term ‘layer’ refers to a discrete film component, which has a substantially uniform composition. For a monolayer film, the terms ‘film’ and ‘layer’ would be synonymous. A ‘layer’ or ‘barrier layer’ may also be in the form of non-planar arrangements or shapes.

As used herein, the term ‘multilayer’ refers to a plurality of layers in a single film structure. The layers can be bonded together by any conventional means known in the art (e.g., coextrusion, lamination, coating or a combination of such).

As used herein, the term ‘substantially’ means to a great or significant extent, predominantly or mostly. That is, the term substantially is used to qualify that there may be a slight variation such that a parameter, measurement, condition or feature is not absolute or is slightly less than 100% (for example, 90%, 95%, 98%, 99%), or may have slight immaterial variations.

As used herein, the term ‘synergistic effect’ refers to an effect, when produced by two or more components that is greater than the additive effects of each individual component when used separately. For example, the synergistic combination of a hydrocarbon resin and a nucleating agent when used to prepare a barrier layer in accordance with the invention disclosed herein improves the barrier properties of the barrier layer to an extent that is greater than the sum or cumulative effect of improvements resulting from or attributable to the use of the hydrocarbon resin and the nucleating agent.

### Abbreviations

The following abbreviations used throughout this specification have the following meanings:

‘HBP’ refers to ‘high barrier polyolefin’.

‘HCR’ refers to ‘hydrocarbon resin’.

‘HDPE’ refers to ‘high density polyethylene’.

‘HHCR’ refers to ‘hydrogenated hydrocarbon resins’

‘MB’ refers to ‘masterbatch’.

‘MFI’ refers to ‘melt flow index’.

‘MFR’ refers to ‘melt flow ratio’.

‘NA’ refers to ‘nucleating agent’.

‘OTR’ refers to ‘oxygen transmission rate’

‘WVTR’ refers to ‘water vapour transmission rate’

### DESCRIPTION OF EMBODIMENTS

The present invention relates generally to films having barrier properties, and methods for preparing such films. The invention is premised on the surprising finding that a polyolefin, such as, e.g., polyethylene, comprising relatively low concentrations of hydrocarbon resin (in particular, concentrations less than a threshold concentration considered essential in the prior art), can achieve suitable or improved barrier properties balanced with good mechanical properties and processibility.

In particular, it has been found that the hydrocarbon resin and nucleating agent may act synergistically to improve the barrier properties, such as the properties described herein, of a barrier layer containing these components. That is, the combination of hydrocarbon resin and nucleating agent in accordance with the present invention may improve the barrier properties of a barrier layer more than a sum or cumulative effect of the hydrocarbon resin and nucleating agent. Preferred embodiments disclosed herein are directed to the use of nucleating agent and hydrocarbon resin in defined ratios and/or amounts. In some embodiments, the synergistic effect is at least 5%, 10%, 15%, 20%, 25%, 30%, 35%, 40%, 45%, or 50% greater than the cumulative effect of the hydrocarbon resin and nucleating agent.

Advantageously, the masterbatch compositions may enable substantially homogenous dispersion of the nucleating agent while using reduced amounts or concentrations of hydrocarbon resin to achieve improved barrier film properties, such as lower WVTR, balanced with good mechanical properties, such as puncture and tear resistance.

In preferred embodiments, the present invention relates to masterbatch compositions comprising a substantially homogenous blend of component ingredients, and methods of producing such masterbatch compositions. In further embodiments, the invention relates to the use of such masterbatch compositions to form a high barrier polyolefin (HBP) composition, and the use of the HBP composition to form a HBP layer in a polyolefin film.

Masterbatch technology is a particularly effective technique for preparing a high barrier polyolefin (HBP) layer in accordance with the present invention. Advantageously, the use of masterbatch technology to prepare a barrier layer in a film may provide one or more benefits, such as for example, improved dispersion of the nucleating agent and/or hydrocarbon resin in polyolefins, such as HDPE, improving the crystalline characteristics of the resultant barrier layer, and facilitating the effectiveness of the compounding, melt-mixing and/or extrusion processes.

In preferred embodiments, the use of masterbatch compositions may provide effective and substantially homogeneous nucleation of a polyolefin, such as HDPE, even when introducing hydrocarbon resin at the same time. In further embodiments, a masterbatch composition comprising both a nucleating agent and hydrocarbon resin at the same time, or a separate nucleating agent masterbatch and hydrocarbon masterbatch to be used simultaneously or sequentially, may balance the requisite amount of each component while retaining suitable processability requirements in such masterbatches. When using such masterbatch(es) for barrier layer formation, a film comprising the barrier layer may achieve significantly improved barrier properties while retaining good mechanical properties.

Accordingly, in preferred embodiments, such masterbatches and their use in methods of preparing barrier layers and films may provide overall cost feasibility in production. Advantageously, embodiments of the present invention provide blended components in selected amounts or ratios which may achieve a substantially homogeneous or uniform dispersion of hydrocarbon resin and nucleating agent in a polyolefin, such as HDPE. In further embodiments, such masterbatches and their methods of use in preparing barrier layers may advantageously reduce the amount of hydrocarbon resin required to provide the desired barrier layer resistance, particularly with regard to WVTR, while still retaining good mechanical properties, such as puncture and tear resistance. A reduction in the amount or concentration of hydrocarbon resin may lower the overall manufacturing cost, which provides a significant commercial advantage.

Other embodiments of the invention disclosed herein relate to methods comprising suitable blending techniques involving, for example, sufficient residence time and energy of mixing, to form a substantially homogeneous blend.

Surprisingly, in accordance with embodiments of the present invention, the use of relatively low concentrations of hydrocarbon resin (e.g., HCR concentrations less than 10% w/w) can lead to improved WVTR, whilst maintaining acceptable mechanical properties, such as puncture and tear resistance. This is in contrast with the conventional understanding in the art that relatively high concentrations of HCR of at least about 10%-20% w/w are required to achieve a suitable W/TR performance, e.g., about 30% decrease in WVTR, in a typical film.

Tear Strength (in machine and transverse directions) is the ability of the film to withstand the extension of a defect or a slit in the film. It is an important property in many film applications. Because of orientation effects, poorly made films can have the undesirable tendency to split readily once a defect or slit is initiated in the film. Tear strength, or more specifically the tear propagation strength, is commonly measured by means of a pendulum in the Elmendorf test in both the machine and transverse directions. This test measures the energy required to propagate a tear formed as a small slit in the film sample.

Puncture resistance involves the capacity of the film to resist damage and puncture from protrusions and pointy structures that tend to induce high stress areas in the material. The property is typically measured by puncture energy which is a measure of the maximum force or energy required to penetrate a material. This type of biaxial stress is seen in packaging films when packing hard protuberances such as pelleted dry foods like cereal and pet foods, and frozen vegetables.

Preferred embodiments of the present invention are based on the surprising finding that when using masterbatch compositions comprising a nucleating agent and hydrocarbon resin, separately or in combination, and a polyolefin, such as HDPE, for the preparation of a barrier layer, the hydrocarbon resin may be used in reduced amounts (e.g., less than 10% w/w) while still retaining or improving resultant barrier layer properties. In other embodiments the use of masterbatch compositions improves dispersion of the nucleating agent and/or hydrocarbon resin within the masterbatch composition(s) and/or together with bulk HDPE in the resultant high barrier polyolefin composition, thereby improving the crystalline characteristics of the resultant barrier layer and/or aiding in the effectiveness of the compounding, melt-mixing and/or extrusion processes.

Accordingly, in one or more embodiments, the invention utilises effective methods of melt-mixing or melt-compounding one or more of hydrocarbon resin, nucleating agent, HCR MB, NA MB or HBP MB with bulk HDPE. In preferred embodiments, masterbatch technology may be used to produce a substantially homogeneous or uniform dispersion of hydrocarbon resin and/or nucleating agent in a polyolefin, such as HDPE. In preferred embodiments, masterbatch technology may be used to produce a substantially homogeneous or uniform dispersion of hydrocarbon resin and/or nucleating agent in bulk HDPE in the resultant high barrier polyolefin composition, for producing a barrier layer. The use of masterbatch technology in accordance with the invention unexpectedly enables barrier films having reduced WVTR to be produced which comprise a relatively low concentration of hydrocarbon resin.

Advantageously, when preparing barrier layers for use in a film, the use of methods and masterbatch compositions as described herein may confer in the film a water vapour transmission rate of no more than about 4 g/m²/day measured at about 38° C. and 90% external relative humidity.

In one or more embodiments, a HBP composition suitable for forming a barrier layer may be prepared by melt compounding a HCR MB and a NA MB into bulk HDPE in an appropriate extrusion apparatus to form the HBP composition. The amounts of the HCR MB and NA MB may be selected to achieve a desired ratio of HCR and NA in the barrier layer. The extrusion apparatus may comprise a single pass or multi-pass extruder, preferably a single pass extruder. In preferred embodiments, the extrusion apparatus is a twin-screw extruder.

By mixing the nucleating agent and/or hydrocarbon resin with a polyolefin, such as HDPE, to form a masterbatch, the nucleating agent or hydrocarbon resin, respectively, can be incorporated directly during processing. Thus, the use of a masterbatch eliminates the need for separate compounding steps to incorporate the nucleating agent or hydrocarbon resin into the bulk HDPE. Due to economic considerations, it is preferable to achieve a desirable concentration of HCR and/or NA in the masterbatch without compromising the ability of the masterbatch to be uniformly blended into the bulk HDPE during melt-mixing and/or the extrusion process. In preferred embodiments, it is desirable to achieve as high a HCR content in the masterbatch as possible, while still balancing the desired properties and cost of the resultant HBP composition.

Nucleating agents are known to be generally difficult to disperse directly into HDPE due to relatively poor miscibility. The use of masterbatch technology to pre-disperse the nucleating agent in a carrier resin, e.g., a polyolefin such as HDPE, as a concentrate to produce a substantially homogeneous dispersion of the nucleating agent in the masterbatch, is a further advantage of the present invention, particularly when the nucleating agent masterbatch is co-blended with a hydrocarbon resin masterbatch to form a HBP masterbatch, which can then be subsequently blended with bulk HDPE to form a HBP composition useful for forming a barrier film. Advantageously, the use of a masterbatch can enable a small quantity of NA to be dispersed within the carrier resin in a convenient and controllable manner.

### Masterbatch Technology

The term ‘masterbatch’ as used herein with reference to the nucleating agent (NA) or hydrocarbon resin (HCR), or combination of NA and HCR, refers to a composition containing a relatively high concentration of NA, HCR, or combination of NA and HCR, in a polyolefin resin, preferably polyethylene resin, and more preferably HDPE. Typically, a hydrocarbon resin masterbatch (HCR MB) may comprise from about 5% to about 80% w/w, or about 2.5% to about 70% w/w, or about 2.5% to about 60% w/w, or about 10% to about 70% w/w, or about 20% to about 60% w/w, or about 5% to about 50% w/w, or about 7.5% to about 45% w/w, or about 10% to about 40% w/w, or about 30% to about 50% w/w, of an HCR, with the remainder being polyolefin resin and optionally one or more conventional additives as described herein. Typically, a nucleating agent masterbatch (NA MB) may comprise from about 0.1% to about 30% w/w, or about 0.2% to about 25% w/w, or about 0.3% to about 25% w/w, or about 0.2% to about 15% w/w, or about 0.3% to about 20% w/w, or about 0.3% to about 15% w/w, or about 0.5% to about 20% w/w, or about 0.5% to about 15%, or about 0.5% to about 10% w/w, of a nucleating agent, with the remainder being polyolefin resin and optionally one or more conventional additives as described herein. Depending on the scale, an appropriate amount (e.g., a portion, or all) of the NA MB and/or HCR MB may be blended with bulk HDPE to give a desired quantity or concentration of nucleating agent and/or hydrocarbon resin in a resultant HBP masterbatch or HBP composition.

An advantage of the present invention is that it may enable the addition of small quantities of nucleating agent and/or hydrocarbon resin to bulk HDPE during an extrusion process in such a way as to achieve homogeneous mixing, preferably resulting in improved barrier properties. Accordingly, embodiments of the present invention relate to:
a high barrier polyolefin masterbatch (HBP MB) composition comprising a nucleating agent and hydrocarbon resin in a polyolefin carrier, preferably HDPE resin;
a nucleating agent masterbatch (NA MB) comprising a nucleating agent in a polyolefin carrier, preferably HDPE resin, and a hydrocarbon resin masterbatch (HCR MB), comprising a hydrocarbon resin in a polyolefin carrier, preferably HDPE resin;
a HBP MB composition formed by melt-mixing the NA MB and HCR MB as described herein, or by melt-mixing NA and HCR with a polyolefin carrier, preferably HDPE resin.

The masterbatch composition(s) may be added to bulk HDPE resin used for forming the barrier layer, and blended with the bulk HDPE resin. The polyolefin carrier in the masterbatch composition(s) is thus subsequently also blended with the bulk HDPE resin.

In preferred embodiments, the polyolefin carrier is selected to provide a resultant viscosity in the masterbatch composition(s) which is lower or approximate the viscosity of the bulk HDPE, preferably to facilitate blending between the masterbatch composition(s) and the bulk HDPE.

In a another embodiment, the polyolefin carrier in the nucleating agent masterbatch has a lower viscosity than that of the bulk HDPE. In a further embodiment, the polyolefin carrier in the nucleating agent masterbatch is HDPE having a higher MFI than that of the bulk HDPE.

In another embodiments, the polyolefin carrier in the hydrocarbon resin masterbatch has a higher or similar viscosity to that of the bulk HDPE. In further embodiments, the polyolefin carrier in the hydrocarbon resin masterbatch is HDPE having a lower or similar MFI to that of the bulk HDPE.

The delivery of the nucleating agent and hydrocarbon resin via a masterbatch may be particularly advantageous as it may facilitate more uniform dispersion of the desired quantities of nucleating agent and/or hydrocarbon resin in the final HBP composition. In addition, the delivery of the nucleating agent and/or hydrocarbon resin via a masterbatch may also advantageously improve the crystalline characteristics of the resultant barrier layer. The delivery of the nucleating agent and/or hydrocarbon resin via a masterbatch may also advantageously facilitate the effectiveness of the compounding, melt-mixing and/or extrusion processes for forming the barrier layer, while retaining good mechanical properties. In preferred embodiments, the inventors have developed masterbatch compositions and methods of use thereof for forming barrier layers, which have one or more advantageous properties. For example, improved processability, mechanical properties, such as stiffness, lowered costs of production, due to the relatively low levels of HCR used.

### NA Masterbatch

A further embodiment of the invention relates to a nucleating agent masterbatch (NA MB), and methods for making the same.

In one more preferred embodiments, the nucleating agent masterbatch comprises from about 0.1% to about 30% w/w, or about 0.2% to about 25% w/w, or about 0.2% to about 15% w/w, or about 0.3% to about 25% w/w, or about 0.3% to about 20% w/w, for example about 5% to about 15%, of nucleating agent.

In one or more embodiments, the nucleating agent masterbatch may comprise from about 0.1% w/w to about 1% w/w, or from about 1% w/w to about 3% w/w, or from about 3% w/w to about 5% w/w, or from about 5% w/w to about 7% w/w, or from about 7% w/w to about 8% w/w, or from about 8% w/w to about 10% w/w, or from about 10% w/w to about 12% w/w, or from about 12% w/w to about 14% w/w, or from about 14% w/w to about 16% w/w, or from about 16% w/w to about 18% w/w, or from about 18% w/w to about 20% w/w, or from about 20% w/w to about 22% w/w, or from about 22% w/w to about 25% w/w, or from about 25% w/w to about 30% w/w, of nucleating agent.

In another embodiment, the invention relates to a method comprising blending a nucleating agent mixture comprising a nucleating agent with a polyolefin carrier, preferably polyethylene, to form a nucleating agent masterbatch. More preferably, the polyethylene is high density polyethylene (HDPE).

Preferably, the nucleating agent mixture comprises the nucleating agent and polyolefin, preferably a polyethylene. The polyethylene may be a polyethylene powder. In a preferred embodiment, the nucleating agent may be dry blended with polyethylene powder to form the nucleating agent mixture.

Preferably, the nucleating agent mixture comprises one or more additive components as described herein.

Another embodiment of the invention relates to a nucleating agent masterbatch produced by the method as described herein.

Preferably, the nucleating agent masterbatch comprises one or more additive components as described herein.

A representative embodiment is illustrated in FIG. 2(a).

### HCR Masterbatch

In another embodiment the invention relates to a hydrocarbon resin masterbatch (HCR MB) and methods for making the same.

In one or more preferred embodiments, the hydrocarbon resin masterbatch comprises from about 5% to about 80% w/w, preferably about 10% to about 70% w/w, more preferably about 20% to about 60% w/w, even more preferably about 30% to about 50% w/w, of a hydrocarbon resin.

In one or more embodiments, the hydrocarbon resin masterbatch may comprise from about 5% w/w to about 10% w/w, or from about 10% w/w to about 15% w/w, or from about 15% w/w to about 20% w/w, or from about 20% w/w to about 25% w/w, or from about 25% w/w to about 30% w/w, or from about 30% w/w to about 35% w/w, or from about 35% w/w to about 40% w/w, or from about 40% w/w to about 45% w/w, or from about 45% w/w to about 50% w/w, or from about 50% w/w to about 55% w/w, or from about 55% w/w to about 60% w/w, or from about 60% w/w to about 65% w/w, or from about 65% w/w to about 70% w/w, or from about 70% w/w to about 80% w/w, of hydrocarbon resin.

In another embodiment, the invention relates to a method comprising blending a hydrocarbon resin with a polyolefin carrier, preferably high density polyethylene (HDPE), to form a hydrocarbon resin masterbatch.

Preferably, the hydrocarbon resin masterbatch comprises one or more additive components as described herein.

Another embodiment of the invention relates to a hydrocarbon resin masterbatch produced by the method as described herein.

A representative embodiment of this aspect is illustrated in FIG. 2(b).

### HBP Masterbatch

In further embodiments, the invention relates to a high barrier polyolefin (HBP) masterbatch composition which may be used for forming a barrier layer in a film.

A HBP masterbatch (HBP MB) refers to a concentrate composition comprising nucleating agent and hydrocarbon resin dispersed in a polyolefin carrier, preferably a polyethylene. More preferably, the polyethylene is high density polyethylene (HDPE). In one embodiment, the HBP MB may be produced by blending an NA MB or NA mixture with an HCR MB or HCR. In another embodiment, the HBP MB may be produced by blending NA and HCR with HDPE.

In various embodiments, a HBP masterbatch comprises one or more nucleating agent(s), preferably one nucleating agent, one or more hydrocarbon resin(s), preferably one hydrocarbon resin, with the remainder of the HBP masterbatch composition comprising a polyolefin carrier, preferably a polyethylene, more preferably HDPE, and optionally one or more conventional additives as described herein. Preferably the nucleating agent is present in the HBP masterbatch in an amount of from about 0.1% to about 30% w/w, or about 0.2% to about 25% w/w, or about 0.2% to about 15% w/w, or about 0.3% to about 25% w/w, or about 0.3% to about 20% w/w, or about 0.3% to about 15% w/w, or about 0.5% to about 20% w/w, or about 0.5% to about 15%, or about 0.5% to about 10% w/w. Preferably, the HCR is present in the HBP masterbatch in an amount of from about 5% to about 80% w/w, or about 2.5% to about 70% w/w, or about 2.5% to about 60% w/w, or about 10% to about 70% w/w, or about 20% to about 60% w/w, or about 5% to about 50% w/w, or about 7.5% to about 45% w/w, or about 10% to about 40% w/w, or about 30% to about 50% w/w.

In one or more embodiments, the HBP masterbatch may comprise from about 0.2% w/w to about 2% w/w, or from about 2% w/w to about 4% w/w, or from about 4% w/w to about 6% w/w, or from about 6% w/w to about 8% w/w, or from about 8% w/w to about 10% w/w, or from about 10% w/w to about 12% w/w, or from about 12% w/w to about 14% w/w, or from about 14% w/w to about 16% w/w, or from about 16% w/w to about 18% w/w, or from about 18% w/w to about 20% w/w, or from about 20% w/w to about 22% w/w, or from about 22% w/w to about 25% w/w, of nucleating agent.

In one or more embodiments the HBP masterbatch may comprise from about 2.5% w/w to about 5% w/w, or from about 5% w/w to about 10% w/w, or from about 10% w/w to about 15% w/w, or from about 15% w/w to about 20% w/w, or from about 20% w/w to about 25% w/w, or from about 25% w/w to about 30% w/w, or from about 30% w/w to about 35% w/w, or from about 35% w/w to about 40% w/w, or from about 40% w/w to about 45% w/w, or from about 45% w/w to about 50% w/w, or from about 50% w/w to about 60% w/w, or from about 60% w/w to about 70% w/w, of hydrocarbon resin.

In another aspect, the invention relates to a method for producing a high barrier polyolefin masterbatch (HBP MB) comprising a nucleating agent (NA) and a hydrocarbon resin (HCR), the method comprising the steps of:
(a) blending a nucleating agent mixture comprising a nucleating agent with a first polyolefin to form a nucleating agent masterbatch (NA MB);
(b) blending hydrocarbon resin in a second polyolefin to form a hydrocarbon resin masterbatch (HCR MB); and
(c) blending the nucleating agent masterbatch and the hydrocarbon resin masterbatch to form the high barrier polyolefin masterbatch (HBP MB).

In another aspect, the invention relates to a method for producing a high barrier polyolefin masterbatch (HBP MB) comprising a nucleating agent (NA) and a hydrocarbon resin (HCR), the method comprising the step of:
blending a nucleating agent masterbatch or nucleating agent mixture with a hydrocarbon resin or hydrocarbon resin masterbatch, and optionally a polyolefin, e.g., a polyethylene such as HDPE, to form the high barrier polyolefin masterbatch (HBP MB).

Preferably, the first polyolefin is a polyethylene, more preferably HDPE.

Preferably, the second polyolefin is a polyethylene, more preferably HDPE.

Step (a) and step (b) may be carried out in any order.

Representative embodiments of this aspect of the invention are illustrated in FIGS. 2(a)-2(c).

In one or more embodiments, the ratio of the nucleating agent masterbatch to the hydrocarbon resin masterbatch is from about 10:1 to about 1:100, or about 25:4 to about 1:80, or about 50:9 to about 1:70, or about 5:1 to about 1:60, or about 5:1 to about 1:50. Preferably, the ratio of nucleating agent masterbatch to hydrocarbon resin masterbatch is from about 5:1 to about 1:60, or about 5:1 to about 1:50.

In another aspect, the invention relates to a method for producing a high barrier polyolefin masterbatch (HBP MB) comprising a nucleating agent (NA) and a hydrocarbon resin (HCR), the method comprising the step of:
blending (i) a nucleating agent mixture comprising a nucleating agent, (ii) hydrocarbon resin and (iii) polyolefin to form the high barrier polyolefin masterbatch.

Preferably, the polyolefin is a polyethylene, more preferably HDPE.

A representative embodiment of this aspect of the invention is illustrated in FIG. 2(d).

In some embodiments of the aspects above, the nucleating agent and hydrocarbon resin are present in the masterbatch in a ratio of about 1:4 to about 1:200, preferably about 1:7 to about 1:150, more preferably about 1:10 to about 1:100 or about 1:15 to about 1:50.

In preferred embodiments, the nucleating agent mixture comprises the nucleating agent and a polyolefin carrier, preferably polyethylene. The polyethylene may be a polyethylene powder. In preferred embodiments, the nucleating agent is dry blended with polyethylene powder to form the nucleating agent mixture.

The first and second polyolefin may the same or different. In some embodiments, the first and second polyolefin may have the same or different MFI. In some embodiments, the first and second polyolefin may have the same or different density. In some embodiments, the first and/or second polyolefin are polyethylene, preferably HDPE, wherein the HDPE is the same or different. In some embodiments, the first and second polyolefin are polyethylene, preferably HDPE, each HDPE having the same or different MFI. In some embodiments, the first and second polyolefin are polyethylene, preferably HDPE, each HDPE having the same or different density. In preferred embodiments, the first polyolefin, preferably polyethylene, more preferably HDPE, has a higher melt index than the second polyolefin, preferably polyethylene, more preferably HDPE.

In other embodiments, the HBP masterbatch may be produced by blending a nucleating agent masterbatch (NA MB) and a hydrocarbon resin or hydrocarbon resin masterbatch (HCR MB) as described herein.

Aspects of the invention also relate to a high barrier polyolefin masterbatch (HBP MB) produced by the methods described herein. Preferably, the HBP masterbatch comprises a synergistic combination of a nucleating agent and a hydrocarbon resin.

In preferred embodiments the blending comprises melt-mixing. Preferably, the melt-mixing is performed for a sufficient period of time to produce a substantially homogeneous dispersion.

In preferred embodiments blending is performed with an extruder, for example a twin-screw extruder.

### Masterbatch Preparation

Masterbatches in accordance with the present invention, including NA MB, HCR MB, and HBP MB, may be prepared using the methods as disclosed herein. General techniques and apparatus for preparing masterbatches are known to those skilled in the art are also described, for example, in WO 00/56806 (Eastman) the entire contents of which are incorporated herein by cross-reference.

In preferred embodiments, masterbatches are formed by melt compounding. In one embodiment, the nucleating agent and hydrocarbon resin may be melt compounded in a polyolefin carrier, such as polyethylene, preferably HDPE, to prepare a HBP masterbatch. Melt compounding techniques may also be used to prepare the barrier layer, e.g., by melt compounding the HBP masterbatch and bulk HDPE.

In preferred embodiments, melt blending is the technique used for masterbatch preparation as it advantageously enhances effective dispersion of the nucleating agent and the hydrocarbon resin in the polyolefin carrier, such as polyethylene, preferably HDPE. A substantially uniform dispersion of nucleating agent and hydrocarbon resin in the polyolefin carrier is preferred as the inventors have surprisingly found that adequate dispersion of nucleating agent and hydrocarbon resin within the polyolefin, preferably uniform or homogeneous dispersion, facilitates desirable barrier properties. Also surprisingly, the inventors have found that improved desirable barrier properties may be achieved with low proportions of hydrocarbon resin. In other embodiments, dry blending may be used for masterbatch preparation.

In one or more embodiments, a masterbatch may be formed by melt compounding a selected amount of the nucleating agent and/or the hydrocarbon resin in a polyolefin carrier, such as polyethylene, preferably HDPE, in a single pass extruder or multi-pass extruder, preferably a twin-screw extruder. In an exemplary embodiment, the twin-screw extruder has barrel zone temperatures set to deliver a constant melt temperature of about 150-220° C.

### HBP Composition

In another aspect, the invention relates to a method for producing a high barrier polyolefin (HBP) composition comprising a synergistic combination of a nucleating agent and a hydrocarbon resin, the method comprising: blending a nucleating agent (NA), a hydrocarbon resin (HCR) and a polyolefin carrier, such as polyethylene, preferably HDPE, to form a substantially homogeneous dispersion using the masterbatch compositions as described herein.

Preferably, the HBP composition comprises a synergistic combination of a nucleating agent and a hydrocarbon resin.

Preferably, HBP composition comprises one or more additive components as described herein.

Various embodiments of this aspect are illustrated in FIGS. 2-5.

The resultant HBP composition produced according to embodiments disclosed herein may be subsequently processed to form a barrier layer. Techniques for forming the barrier layer are described herein. In one embodiment, the barrier layer is formed by extrusion. Suitable extrusion techniques are known in the art and representative techniques are described herein.

In one or more embodiments, blending may be achieved by melt compounding (e.g., melt mixing) the respective components in order to blend the components together. Melt compounding may be achieved using techniques and apparatus known to those skilled in the art, for example, an extruder or other suitable blending apparatus. The extruder may be a twin-screw extruder or a single screw extruder. Preferably, the extruder is a twin-screw extruder.

In one or more embodiments, suitable amounts or proportions of nucleating agent masterbatch and hydrocarbon resin masterbatch may be blended with bulk HDPE by melt compounding. A desired amount of nucleating agent and hydrocarbon resin may be introduced into the HBP composition for melt compounding with the bulk HDPE by blending the NA masterbatch and HCR masterbatch with bulk HDPE. The NA masterbatch may be introduced to the bulk HDPE before or after the HCR masterbatch. Alternatively, the NA masterbatch and HCR masterbatch may be introduced simultaneously into the bulk HDPE at the same or different rates.

A desired amount or proportion of nucleating agent and hydrocarbon resin may be introduced into the HBP composition for melt compounding with the bulk HDPE by adding (e.g., blending) a HBP masterbatch comprising nucleating agent and hydrocarbon resin with bulk HDPE in accordance with embodiments as described herein.

In one or more embodiments, the invention relates to a method for producing a high barrier polyolefin (HBP) composition comprising the steps of:
(a) blending a mixture comprising a nucleating agent in a first polyolefin to form a nucleating agent masterbatch (NA MB);
(b) blending hydrocarbon resin in a second polyolefin to form a hydrocarbon resin masterbatch (HCR MB);
(c) blending the nucleating agent masterbatch and the hydrocarbon resin masterbatch to form a high barrier polyolefin masterbatch (HBP MB);
(d) blending the high barrier polyolefin masterbatch (HBP MB) and bulk HDPE to form the high barrier polyolefin (HBP) composition.

In one or more embodiments, the invention relates to a method for producing a high barrier polyolefin (HBP) composition comprising the steps of:
(a) blending a nucleating agent masterbatch or nucleating agent mixture with a hydrocarbon resin or hydrocarbon resin masterbatch, and optionally a polyolefin, e.g., a polyethylene such as HDPE, to form a high barrier polyolefin masterbatch (HBP MB), (b) blending the high barrier polyolefin masterbatch (HBP MB) and bulk HDPE to form the high barrier polyolefin (HBP) composition.

A representative embodiment is illustrated in FIGS. 2 and 3.

In one or more embodiments, the invention relates to a method for producing a high barrier polyolefin (HBP) composition comprising the steps of:
(a) blending a mixture comprising a nucleating agent in a first polyolefin to form a nucleating agent masterbatch (NA MB);
(b) blending hydrocarbon resin in a second polyolefin to form a hydrocarbon resin masterbatch (HCR MB);
(c) blending the nucleating agent masterbatch, the hydrocarbon resin masterbatch and bulk HDPE to form the high barrier polyolefin (HBP) composition.

Preferably, the first polyolefin is a polyethylene, more preferably HDPE.

Preferably, the second polyolefin is a polyethylene, more preferably HDPE.

A representative embodiment is illustrated in FIGS. 2(a), 2(b) and 4.

Those skilled in the art will be able to readily determine suitable quantities of the respective masterbatch(es) and bulk HDPE that are to be blended together to produce a HBP composition having desired quantities or concentrations of nucleating agent and hydrocarbon resin, having regard to the concentration of these components in the respective masterbatch compositions. In one or more embodiments, the amount of nucleating agent masterbatch may be in the range of from about 0.04% to about 30% w/w of the HBP composition, and the amount of hydrocarbon resin masterbatch may be in the range of from about 0.14% to about 70% w/w of the HBP composition.

In one or more embodiments, the HBP composition may comprise from about 0.04% w/w to about 0.1% w/w, or from about 0.1% w/w to about 0.5% w/w, or from about 0.5% w/w to about 1% w/w, or from about 1% w/w to about 3% w/w, or from about 3% w/w to about 5% w/w, or from about 5% w/w to about 7% w/w, or from about 7% w/w to about 8% w/w, or from about 8% w/w to about 10% w/w, or from about 10% w/w to about 12% w/w, or from about 12% w/w to about 14% w/w, or from about 14% w/w to about 16% w/w, or from about 16% w/w to about 18% w/w, or from about 18% w/w to about 20% w/w, or from about 20% w/w to about 22% w/w, or from about 22% w/w to about 25% w/w, or from about 25% w/w to about 30% w/w, of nucleating agent masterbatch.

In one or more embodiments the HBP composition may comprise from about 0.14% w/w to about 1% w/w, or from about 1% w/w to about 5% w/w, or from about 5% w/w to about 10% w/w, or from about 1% w/w to about 10% w/w, or from about 10% w/w to about 20% w/w, from about 20% w/w to about 25% w/w, or from about 25% w/w to about 30% w/w, or from about 30% w/w to about 35% w/w, or from about 35% w/w to about 40% w/w, or from about 40% w/w to about 45% w/w, or from about 45% w/w to about 50% w/w, or from about 50% w/w to about 55% w/w, or from about 55% w/w to about 60% w/w, or from about 60% w/w to about 65% w/w, or from about 65% w/w to about 70% w/w, of hydrocarbon resin masterbatch.

In one or more embodiments, a nucleating agent masterbatch or nucleating agent mixture and a hydrocarbon resin or hydrocarbon resin masterbatch are blended with bulk HDPE to produce a HBP composition having a desired or suitable quantity and distribution of nucleating agent and hydrocarbon resin dispersed within the HBP composition, in particular, to achieve a synergistic effect.

In one or more embodiments, a suitable amount of HBP masterbatch may be blended with bulk HDPE by melt compounding. In one or more embodiments an amount of HBP masterbatch in the range of from about 0.2% to about 75% w/w may be combined with a desired quantity of the bulk HDPE resin to produce a HBP composition having a desired quantity or proportion and dispersion of nucleating agent and hydrocarbon resin.

In one or more embodiments the HBP composition may comprise from about 0.2% w/w to about 2% w/w, or from about 2% w/w to about 4% w/w, or from about 4% w/w to about 6% w/w, or from about 6% w/w to about 8% w/w, or from about 8% w/w to about 10% w/w, or from about 10% w/w to about 12% w/w, or from about 12% w/w to about 14% w/w, or from about 14% w/w to about 16% w/w, or from about 16% w/w to about 18% w/w, or from about 18% w/w to about 20% w/w, or from about 20% w/w to about 22% w/w, or from about 22% w/w to about 25% w/w, or from about 25% w/w to about 30% w/w, or from about 30% w/w to about 35% w/w, or from about 35% w/w to about 40% w/w, or from about 40% w/w to about 45% w/w, or from about 45% w/w to about 50% w/w, or from about 50% w/w to about 55% w/w, or from about 55% w/w to about 60% w/w, or from about 60% w/w to about 65% w/w, or from about 65% w/w to about 70% w/w, or from about 70% w/w to about 75% w/w, of HBP masterbatch.

In one embodiment, the amount of HBP masterbatch blended with the bulk HDPE resin is about 7% by weight, based on the total weight of masterbatch composition and HDPE.

In one more preferred embodiments, the nucleating agent masterbatch comprises from about 0.1% to about 30% w/w of nucleating agent.

In one or more embodiments, the nucleating agent masterbatch may comprise from about 0.1% w/w to about 1% w/w, or from about 1% w/w to about 3% w/w, or from about 3% w/w to about 5% w/w, or from about 5% w/w to about 7% w/w, or from about 7% w/w to about 8% w/w, or from about 8% w/w to about 10% w/w, or from about 10% w/w to about 12% w/w, or from about 12% w/w to about 14% w/w, or from about 14% w/w to about 16% w/w, or from about 16% w/w to about 18% w/w, or from about 18% w/w to about 20% w/w, or from about 20% w/w to about 22% w/w, or from about 22% w/w to about 25% w/w, or from about 25% w/w to about 30% w/w, of nucleating agent.

In one more preferred embodiments, the hydrocarbon resin masterbatch comprises from about 5% to about 80% w/w of hydrocarbon resin.

In one or more embodiments, the hydrocarbon resin masterbatch may comprise from about 5% w/w to about 10% w/w, or from about 10% w/w to about 15% w/w, or from about 15% w/w to about 20% w/w, or from about 20% w/w to about 25% w/w, or from about 25% w/w to about 30% w/w, or from about 30% w/w to about 35% w/w, or from about 35% w/w to about 40% w/w, or from about 40% w/w to about 45% w/w, or from about 45% w/w to about 50% w/w, or from about 50% w/w to about 55% w/w, or from about 55% w/w to about 60% w/w, or from about 60% w/w to about 65% w/w, or from about 65% w/w to about 70% w/w, or from about 70% w/w to about 80% w/w, of hydrocarbon resin.

In one or more embodiments, the ratio of the nucleating agent masterbatch to hydrocarbon resin masterbatch is from about 10:1 to about 1:100, or about 25:4 to about 1:80, or about 50:9 to about 1:70, or about 5:1 to about 1:60, or about 5:1 to about 1:50.

Preferably, the ratio of nucleating agent masterbatch to hydrocarbon resin masterbatch is from about 5:1 to about 1:60, or about 5:1 to about 1:50.

Preferably, the nucleating agent mixture comprises the nucleating agent and polyethylene. The polyethylene may be a polyethylene powder. In a preferred embodiment the nucleating agent is dry blended with polyethylene powder to form the nucleating agent mixture.

In a preferred embodiment, the polyolefin is a polyethylene, preferably high density polyethylene (HDPE). Accordingly, in one or more embodiments, the bulk HDPE that is melt compounded with nucleating agent masterbatch and hydrocarbon resin masterbatch, with hydrocarbon resin and a nucleating agent mixture, or with nucleating agent masterbatch and hydrocarbon resin to form the HBP composition may be the same as, or different from, the HDPE that is contained in the respective masterbatch compositions. It is generally preferred that the polyolefin, preferably HDPE, in masterbatch composition(s) is essentially linear without long-chain branching. In preferred embodiments the polyolefin, preferably HDPE, in masterbatch composition(s) is of the same type or grade as the bulk HDPE that is blended with the masterbatch composition(s) to form the HBP composition as this may avoid or minimise incompatibility issues or the risk of dilution or deterioration of the properties of the barrier layer that may arise from the use of different types or grades of HDPE resin. Preferably, the polyolefin in the masterbatch composition(s), the polyolefin preferably being HDPE, and the bulk HDPE are essentially linear without long-chain branching.

### Hydrocarbon Resin

Hydrocarbon resins (HCRs) useful in the present invention include low molecular weight materials derived from crude olefin feeds produced in the petroleum cracking process or cyclic olefin copolymers. Examples of these crude olefin feeds include a light olefin fraction having an average carbon number of 5 carbon atoms per olefin molecule (C5 feeds) or cyclic olefins having an average of 6-9 carbon atoms per olefin molecule. Hydrocarbon resins produced from olefin streams rich in dicyclopentadiene (DCPD), from terpene olefins such as limonene derived from citrus products, or derived from the polymerisation of one or more pure monomer feedstocks selected from the group consisting of styrene, α-methylstyrene, 4-methylstyrene, norbornene and vinyl toluene, may also be utilised.

In one or more embodiments, the hydrocarbon resin has a weight average molecular weight (MW) of no more than about 10,000 Daltons. In some embodiments, the hydrocarbon resin has a weight average molecular weight (MW) of no more than about 5,000 Daltons, preferably no more than about 2,000 Daltons, more preferably no more than about 1,000 Daltons, most preferably wherein the hydrocarbon resin has a weight average molecular weight of about 400 to about 800 Daltons

The MW of the resins can be determined using techniques known to those skilled in the art, including for example, size exclusion chromatography (SEC) using polystyrene as a standard.

In some embodiments it is preferable that the hydrocarbon resin be aliphatic in character to aid its compatibility with the polyolefin carrier, preferably wherein the polyolefin is HDPE. Hydrocarbon resins of aliphatic type resin can be prepared by copolymerisation with other unsaturated monomers such as ethylene or converting hydrocarbon resin having unsaturated character by catalytic hydrogenation. By hydrogenation, residual unsaturated olefinic and/or aromatic groups in the hydrocarbon resin are converted to a saturated species by reduction with hydrogen. Hydrogenation reactions can be carried under various conditions, examples being at temperatures in the range of about 150° C. to about 320° C., using hydrogen pressures between about 50 to about 2,000 psi, in the presence of a catalyst such as Ni metal supported on carbon black.

In a preferred embodiment, hydrocarbon resins described herein may be hydrogenated hydrocarbon resins (HHCR) or cyclic olefin copolymer. Such hydrogenated hydrocarbon resins may be partially or fully hydrogenated. In one embodiment, hydrogenated resins with little residual unsaturated groups can be desired. For example, a preferred type of hydrogenated hydrocarbon resin may have more than about 80%, preferably more than about 90%, even more preferably more than about 95%, of residual olefinic and/or aromatic groups hydrogenated.

In one or more embodiments, the hydrocarbon resin comprises a hydrogenated hydrocarbon resin selected from the group consisting of hydrogenated C5 resins, C9 resins, norbornene ethylene copolymer resins, hydrogenated aromatic resins, and hydrogenated dicyclopentadiene resins, or any combination thereof.

A representative example of hydrocarbon resins are resins derived from the polymerisation of crude C5 and/or C9 feedstocks, which are hydrogenated. A C5 feedstock is the olefin stream produced during petroleum cracking comprised of hydrocarbon olefin components having about 5 carbon atoms per molecule. Examples of olefins found in a C5 feed include but are not limited to: trans-1,3-pentadiene, cis-1,3-pentadiene, 2-methyl-2-butene, cyclopentadiene, cyclopentene, and dicyclopentadiene. A C9 feedstock is the olefin stream produced during petroleum cracking comprised of hydrocarbon olefin components having about 9 carbon atoms per molecule. Examples of olefins found in a C9 feed include but are not limited to: styrene, α-methylstyrene, indene, various methyl substituted indenes, 4-methylstyrene, p-methylstyrene and ethylstyrene.

In one embodiment, the hydrocarbon resin comprises a hydrogenated C5 hydrocarbon resin, hydrogenated C9 hydrocarbon resin or norbornene ethylene copolymer resin.

In another embodiment, the hydrocarbon resin comprises a hydrogenated C5/C9 hydrocarbon resin. Such resins may be produced using techniques known in the art, for example by copolymerising C5 and C9 feedstocks and hydrogenating the resultant resin, or by blending hydrogenated resins derived from such feedstocks.

Another example of hydrocarbon resins suitable for use in accordance with the present invention are resins derived from the polymerisation of olefin feeds rich in dicyclopentadiene (DCPD). DCPD-rich hydrocarbon resins can be produced by thermally polymerising olefin streams containing between about 50% to about 100% DCPD at temperatures in the range of about 200° C. to about 325° C. to produce resin products which can be hydrogenated to form fully saturated materials. In another embodiment, the hydrocarbon resin may comprise a hydrogenated dicyclopentadiene resin.

Another example of a hydrocarbon resin that can be utilised in accordance with the present invention are resins derived from the polymerisation of pure monomers such as styrene, α-methylstyrene, 4-methylstyrene, vinyl toluene, or any combination of these or similar pure monomer feedstocks. The product produced by this polymerisation is aromatic in character, but may be converted to an aliphatic type resin by catalytic hydrogenation via a similar process as that described above. In another embodiment, the hydrocarbon resin may comprise a hydrogenated aromatic resin.

In another example, hydrocarbon resins suitable for use in accordance with the present invention may be derived from the polymerisation of terpene olefins, such as α-pinene, β-pinene, or d-limonene. These resins are aliphatic-type materials and hydrogenation is generally not required to achieve aliphatic character.

Accordingly, in one or more embodiments, the hydrocarbon resin is selected from the group consisting of a hydrogenated C5 resin, a hydrogenated C9 resin, a norbornene ethylene copolymer resin, a hydrogenated aromatic resin, a hydrogenated dicyclopentadiene resin, and a combination thereof.

Preferably, hydrogenated hydrocarbon resins suitable for use in the present invention have a low softening point, which is preferably below 180° C. The low softening point may help promote the resin's compatibility and interaction with the polyolefin in which the resin is dispersed, wherein the polyolefin is preferably HDPE.

The softening point of a hydrogenated hydrocarbon resin may be determined using methods and techniques known to those skilled in the art. An exemplary method for measuring the softening point of the resin is the ring and ball method described in ASTM E28.

In one or more embodiments, the hydrogenated hydrocarbon resin has a softening point of less than about 160° C., preferably less than about 150° C., more preferably less than about 140° C., preferably at about 124° C., measured according to ASTM E28.

In a preferred embodiment, the hydrocarbon resin is a hydrogenated hydrocarbon resin, preferably the hydrogenated hydrocarbon resin has a softening point of less than about 140° C. as measured according to ASTM E28.

A range of commercially available hydrogenated hydrocarbon resins may be suitable for use in accordance with the present invention. Representative non-limiting examples of commercially available hydrogenated hydrocarbon resin include: Piccotac 1115, Eastotac™ H-100W, H-115W, H-130W and H-142W; Regalite™ R1090 and R1125 (commercially available from Eastman Chemical company); Arkon P100, Arkon P125, Arkon P140 (commercially available from Arakawa Chemical Company, Japan); Bitoner LH 3115, LH 3100, DH 1100, DH1120, LH3100W and LH2100W (commercially available from Qingdao Bater Chemical Co., Ltd); Fuclear FD-100, Fuclear FD-120 (commercially available from UPM Sun-Tack); Oppera™ and Escorez™ resins (commercially available from ExxonMobil Chemical Company); HCR-D100 Series of Hydrogenated DCPD Resins (commercially available from Puyang Tiancheng Chemical Company); Regalrez™ hydrocarbon resin (commercially available from Eastman Chemical Company); and Clearon P series resins (commercially available from Yasuhara Chemicals Japan).

Examples of commercially available hydrogenated hydrocarbon resins that may be particularly useful in accordance with embodiments of the present invention include Escorez™ 5320, Escorez™ 5340, Topas® 8007F-04, Oppera™ PR100N and Oppera™ PR120.

An advantage of one or more embodiments of the present invention is that a relatively small amount of hydrocarbon resin may be incorporated into the barrier layer of the film of the invention. Advantageously, it has been found that a small quantity of hydrocarbon resin, in particular hydrogenated hydrocarbon resin, can be blended with a nucleating agent and bulk HDPE to achieve substantial improvements in barrier properties, particularly WVTR.

In one or more embodiments, the hydrocarbon resin may be included in the barrier layer in an amount of from about 0.1% to about 10% by weight, based on the total weight of components in the barrier layer. In particular embodiments, the barrier layer comprises from 0.5% by weight up to about 7% by weight, preferably from 1% by weight up to about 4% by weight, of the hydrocarbon resin. Preferably, the hydrocarbon resin is a hydrogenated hydrocarbon resin or a cyclic olefin copolymer.

### Nucleating Agent

Nucleating agents are additives that form nuclei in a polymer melt, which promote crystal growth and the formation of small but numerous crystalline regions in the polymer as it solidifies from the melt state.

Any suitable and effective nucleating agent may be used in accordance with the present invention. Preferred nucleating agents are compatible with a polyolefin carrier and can be dispersed in the polyolefin, preferably wherein the polyolefin is polyethylene, preferably HDPE. Polyolefin-compatible, preferably HDPE-compatible, nucleating agents may be inorganic or organic. Combinations of two or more nucleating agents may be used. In preferred embodiments, a single nucleating agent is used.

Inorganic nucleating agents may be nanoscale particulate inorganic materials. Examples of inorganic nucleating agents include but are not limited to: calcium carbonate; talc; barium sulfate; silicon dioxide; carbon particles such as expanded graphite or carbon nanotubes; polyhedral oligomeric silsesquioxane (POSS); nanoclays such as halloysite and montmorillonite; silicate minerals such as vermiculite; and combinations thereof.

Organic nucleating agents may be suitable organic materials. Examples of organic nucleating agents include but are not limited to: carboxylic acid metal salts such as benzoic acid metal salts, phthalate metal salts, hydrophthalic acid metal salts and bicycloheptane dicarboxylic acid metal salts; phosphates; anthracene; zinc monoglycerolate; benzoates; organic derivatives of dibenzylidene sorbitol; sorbitol acetals; metal salts of branched alkyl phosphonic acid; cyclic organophosphate metal salts; and combinations thereof.

Other examples of nucleating agents are known to those skilled in the art and are described, for example, in WO 2022/226247, WO 2022/226249 and WO 2022/226250 (Milliken), the entire contents of which are incorporated herein by cross-reference.

In one or more embodiments the nucleating agent is selected from a hydrophthalic acid metal salt, a bicycloheptane dicarboxylic acid metal salt, or a combination thereof. In one embodiment, the hydrophthalic acid metal salt is a hexahydrophthalic acid metal salt or a heptahydrophthalic acid metal salt. In one embodiment, the nucleating agent is preferably a hexahydrophthalic acid metal salt.

Metal salts of nucleating agents include but are not limited to zinc, magnesium, sodium and calcium salts and mixtures of such metal salts.

In one embodiment, the nucleating agent is bicyclo[2,2,1]heptane-2,3-dicarboxylate disodium salt, which is commercially available in Hyperform® HPN-68L from Milliken. In another preferred embodiment, the nucleating agent is hexahydrophthalic acid calcium salt, which is commercially available in Hyperform® HPN-20E from Milliken. Combinations of these nucleating agents may also be used.

The nucleating agent may be present in the barrier layer in an effective amount and generally can be present in an amount of from about 0.01% to about 1% by weight, based on the total weight of components in the barrier layer. In one embodiment, the nucleating agent is present in the barrier layer in an amount of from about 0.03% to about 0.5% by weight. In a particular embodiment, the nucleating agent may be present in the barrier layer in an amount of from about 0.05% to about 0.2% by weight, or from about 0.075% to about 0.125% by weight.

### High Density Polyethylene (HDPE)

High density polyethylene (HDPE) is a preferred embodiment of polyethylene, which is a preferred embodiment of the polyolefin carrier used in the masterbatch composition(s) as disclosed herein.

HDPE is also the resin into which the masterbatch compositions is/are mixed to form the HBP composition. In this context, HDPE is referred to as bulk HDPE.

HDPE is a class of polyethylene in which the generally linear polymer has a low level of branching in the polymer chain. As a result of its regular structure, HDPE is a highly crystalline material. Preferably, the HDPE is selected from those suitable for forming layers and films.

In some preferred embodiments, the HDPE is ‘substantially linear’. This means that the HDPE is essentially free of long chain branching and relatively narrow in molecular weight distribution. Long chain branching can be measured by NMR, 3D-GPC, and rheology.

In one or more embodiments, HDPE useful in accordance with the present invention may be a homopolymer or copolymer of ethylene. The terms ‘high density polyethylene’ and ‘HDPE’ are therefore used herein to denote homopolymers of ethylene as well as copolymers of ethylene.

The term ‘ethylene homopolymer’ refers to an ethylene polymer that consists substantially (i.e., at least 90% by weight, preferably at least 95% by weight, more preferably at least 97% by weight) of ethylene and thus a polyethylene homopolymer preferably predominately comprises ethylene monomer.

The term ‘ethylene copolymer’ refers to a polymer that is formed from the copolymerisation of ethylene and at least one co-monomer. Preferably, the co-monomer is at least one alpha-olefin. The alpha-olefin co-monomer may comprise from 3 to 20 carbon atoms, preferably from 4 to 8 carbon atoms. In some embodiments, the alpha-olefin co-monomer is selected from the group consisting of 1-butene, 1-pentene, 1-hexene, 1-heptene, 1-octene, 1-decene, and mixtures thereof. In one preference, the alpha-olefin co-monomer is selected from the group consisting of C4, C5 and C6 alkenes, and mixtures thereof, and preferably, may be selected from the group consisting of 1-butene, 1-pentene, 1-hexene and mixtures thereof.

In one or more embodiments, HDPE suitable for use in accordance with the present invention may have a density in the range from about 0.94 to about 0.97 g/cm³ at 23° C. The density of a HDPE can be determined by those skilled in the art using known techniques. An exemplary technique is described in ASTM D792. Density is a measure of HDPE crystallinity, where higher density relates to a higher level of crystallinity developed by the polymer.

In a preferred embodiment, the HDPE, (including e.g., bulk HDPE) has a density of at least about 0.940 g/cm³ at 23° C. as measured according to ASTM D792. In one embodiment, the HDPE may have a density in the range of from about 0.95 to about 0.965 g/cm³ at 23° C. as measured according to ASTM D792.

The bulk HDPE may have a melt flow index (MFI) as measured according to ISO 1133 in the range of from about 0.08 to 40.0 g/10 min, at 190° C. and 2.16 kg. Melt flow index (MFI) provides an indication of the flowability and processability of the HDPE resin and is related to the viscosity of the HDPE in its molten state. MFI may also be related to the average molecular weight of the polymer chains in the HDPE resin. A lower melt index at a defined load and temperature is indicative of higher viscosity and a higher average molecular weight for the HDPE. In one or more preferred embodiments, the HDPE has a MFI in a range of from about 0.08 to 20.0 g/10 min, or from about 0.10 to 10 g/10 min, or from about 0.10 to 4 g/10 min, or from about 0.5 to 3 g/10 min, or from about 0.8 to 2.0 g/10 min at 190° C. and 2.16 kg as measured according to ISO 1133.

In one or more embodiments, the MFI of the HDPE, when used as the polyolefin carrier in one or more of the relevant masterbatch(es), is the same as or different to the MFI of the bulk HDPE. In a preferred embodiment, the HDPE in the nucleating agent masterbatch has a higher MFI than that of the bulk HDPE. In preferred embodiments, the HDPE in the hydrocarbon resin masterbatch has a lower or similar MFI to that of the bulk HDPE.

Polyethylene is generally composed of a mixture of polymer molecules with a distribution of different molecular weights, which can be graphically represented with a molecular weight distribution curve. In one or more embodiments, the HDPE may have a weight average molecular weight in the range of from about 5,000 to 5,000,000 g/mol.

In some embodiments, the ratio of viscosities of a HDPE measured at two different shear rates may be used to provide an indication of the breadth of the molecular weight distribution for the HDPE. In some instance, the Melt Flow Index Ratio (MFR), which is the ratio of the MFI measured under standard conditions at 190° C. with a load of 21.6 kg to the MFI measured under the same conditions using a load of 2.16 kg (e.g., MI₂₁/MI₂) can provide an indication of the breadth of the molecular weight distribution. In some embodiments of the invention, the bulk HDPE has a MI₂₁/MI₂ melt flow index ratio (MFR) of less than 100, preferably less than 70, more preferably less than 60. In some embodiments, the MFR of the resin is less than 50, more preferably less than 45.

In one or more embodiments, HDPE comprises at least one polyethylene polymer, and may comprise a blend of two or more polyethylene polymers, such as a blend of a polyethylene copolymer and a polyethylene homopolymer or a blend of two or more polyethylene homopolymers or copolymers of different molecular weight and/or composition.

In accordance with embodiments of the present invention, HDPE described herein may optionally contain one or more other additives. Representative examples of additives include antioxidants (including primary and secondary antioxidants), antacid metal salts, fire retardants, lubricants, UV stabilizers, antistatic agents, processing aids, and the like. If desired, such additives may be added to the extruder and melt compounded into the relevant masterbatch or HBP composition.

For the avoidance of doubt, for each respective embodiment described herein, the nucleating agent, hydrocarbon resin and polyolefin, preferably polyethylene, more preferably HDPE, may be selected from any one of those described herein.

### Barrier Layer

In another aspect the invention relates to a method for producing a barrier layer, the method comprising forming the barrier layer from an HBP composition as described herein. Additional embodiments of the present invention also relates to barrier layers produced by such methods.

In a preferred embodiment the HBP composition is extruded to form the barrier layer.

In another embodiment, the invention provides a barrier layer produced by the method as described herein.

In another aspect, the invention relates to a method for preparing a barrier layer for use in a film, the method comprising blending an HBP masterbatch comprising a synergistic combination of nucleating agent, a hydrocarbon resin and polyolefin, with bulk HDPE to form an HBP composition; and forming the barrier layer from the resultant blended HBP composition, wherein the polyolefin is preferably polyethylene, more preferably HDPE.

In another embodiment an HBP composition may be formed by blending a nucleating agent masterbatch, polyolefin and hydrocarbon resin without the use of a hydrocarbon resin masterbatch, wherein the polyolefin is preferably polyethylene, more preferably HDPE.

A further embodiment of the present invention relates to a method for producing a barrier layer for a film, the method comprising: (a) melt-mixing a nucleating agent masterbatch into a bulk HDPE, (b) simultaneously or sequentially melt-mixing a hydrocarbon resin masterbatch into the bulk HDPE of step (a) to form an HBP composition, and (c) forming the barrier layer from the HBP composition. In an embodiment the nucleating agent masterbatch may be blended into the bulk HDPE in an amount of from about 0.04% w/w to about 30% w/w, preferably from about 0.1% w/w to about 10% w/w of the barrier layer. In an embodiment the hydrocarbon resin masterbatch may be blended into the bulk HDPE in an amount of from about 0.14% w/w to about 70% w/w, preferably from about 0.5% w/w to about 25% w/w of the barrier layer.

### Barrier Film

The barrier layer described herein may be incorporated within a film to form part of the film. The film according to the present invention incorporates a barrier layer as described herein.

Accordingly, in another aspect the invention relates to method of reducing the water vapour transmission rate of a film, the method comprising incorporating a barrier layer as described herein into the film. Preferably, the film has a water vapour transmission rate of no more than about 4 g/m²/day measured at about 38° C. and 90% external relative humidity.

As used herein, the term ‘film’ may refer to a substantially planar material of any thickness. In some embodiments, a film as described herein can be a substantially planar material having an average thickness of not more than about 500 μm, e.g., from about 10 μm to about 500 μm, preferably from about 20 μm to about 200 μm, or from about 25 μm to about 100 μm, or from about 30 μm to about 80 μm, or from about 35 μm to about 70 μm, or from about 40 μm to about 60 μm. Films in the form of non-planar arrangements or shapes are also contemplated, for example, the film may comprise a layer or layers in an article, which is formed by blow moulding or injection moulding.

A film comprising the barrier layer may be a monolayer (i.e., single layer) film consisting only of the barrier layer, which is generally in the form of a substantially planar sheet.

Alternatively, the film may be a multilayer film in which the barrier layer is a component of the film together with other layers. Thus the term ‘multilayer’ refers to a plurality of layers in a single film structure. The layers can be combined together by any conventional means known in the art, for example, by co-extrusion, lamination, or a combination thereof. The multilayer film described in the present application may comprise as many layers as desired, such as for example, at least three, four, five, or more film layers. At least one of the layers in the multilayer film is the barrier layer described herein. The barrier layer may be sandwiched in between other layers of the multilayer film. For example, multilayer film may comprise three layers and the barrier layer may be the centre core layer of the multilayer film.

Other layers in the multilayer film may comprise or be composed of conventional materials suitable for films for packaging applications, including other oxygen and/or water vapour barrier materials.

Films of the present invention may be orientated or non-orientated films.

Oriented films may be molecularly oriented in the longitudinal direction (LD) and/or in the transverse (i.e., sideways) direction (TD). Orientation of the film in either or both directions may be achieved by any suitable techniques, for example by the well-known bubble and/or tenter processes.

Films of the present invention advantageously exhibit one or more favourable barrier properties, including low water vapour transmission rates and/or oxygen transmission rates. Trends in water vapour and oxygen transmission rates can be correlated for a particular film. Accordingly, a film exhibiting a low water vapour transmission rate would be expected to exhibit a corresponding low oxygen transmission rate.

In one or more embodiments, films according to the present invention may have a water vapour transmission rate (WVTR) of no more than about 4 g/m²/day measured at about 38° C. and 90% external relative humidity. The testing temperature may be within ±10% of 38° C. (100° F.).

Water vapour transmission rate (WVTR) is the steady state rate at which water vapour permeates through a film at specified conditions. WVTR is normally expressed in g/m²/day (i.e., 24 hrs), and conditions of about 38° C. and 90% relative humidity. WVTR can increase with humidity and also temperature or pressure rises. A suitable method for determining WVTR is described in ASTM E3. In one embodiment, WVTR is determined with a film having a thickness of not less than about 40 μm.

In one or more embodiments, the barrier layer may largely be responsible for imparting the desired WVTR property to the film.

In some embodiments, the barrier layer per se may have a property of water vapour transmission rate of no more than about 4 g/m²/day measured at about 38° C. and 90% external relative humidity. For example, in embodiments where the film is a monolayer film, the barrier layer per se may have a water vapour transmission rate of no more than about 4 g/m²/day, measured at about 38° C. and 90% external relative humidity, preferably when the film has a thickness of from about 40 μm to about 60 μm.

In embodiments in which the film is a multilayer film, the film may have a water vapour transmission rate of no more than about 4 g/m²/day, no more than about 3.5 g/m²/day, preferably no more than about 3 g/m²/day, preferably no more than about 2.5 g/m²/day, preferably no more than about 2.0 g/m²/day, preferably no more than about 1.5 g/m²/day, preferably no more than about 1.0 g/m²/day, preferably no more than about 0.5 g/m²/day measured at about 38° C. and 90% external relative humidity, preferably when the film has a thickness of from about 40 μm to about 60 μm.

In accordance with the present invention, barrier films may have a low oxygen transmission rate. (OTR). OTR is the steady state rate at which oxygen permeates through a film at specified conditions. OTR is normally expressed in cc/m²/day (i.e., 24 hrs) and conditions of 23° C. and 0% relative humidity. Higher values of OTR can be observed in a humid environment, and can increase as temperature or pressure increases. In one embodiment, films of the present invention may have an OTR of not more than 1,000 cc/cm²/day, as determined with a film having a thickness of not less than about 40 μm. OTR may be determined using methods known to those skilled in the art. A suitable method for determining OTR is described in ASTM D3985.

Advantageously, the barrier layer described herein is capable of controlling the permeation of oxygen and/or water vapour. In one embodiment, the barrier layer is capable of inhibiting or reducing oxygen and/or water vapour permeation. Accordingly, films comprising the barrier layer may exhibit W/TR and/or OTR values that are lower than that of conventional films.

In accordance with embodiments of the present invention the barrier layer may be formed from a HBP composition as defined herein. In one or more embodiments the HBP composition and resultant barrier layer comprise one or more polyolefins, preferably HDPE, one or more nucleating agent(s) and one or more hydrocarbon resin(s). Preferably the HBP composition and barrier layer comprise one nucleating agent and one hydrocarbon resin. Conventional techniques for forming polymer layers and films can be used to prepare the barrier layer from the HBP composition.

Techniques for preparing the barrier layer are known to those skilled in the art. According to one embodiment, the barrier layer may be formed by extruding a melt compounded HBP composition comprising a synergistic blend of nucleating agent and hydrocarbon resin dispersed within a polyolefin, preferably HDPE, to form a substantially planar sheet or web. This may involve for example, extrusion of the molten HBP composition through a slit die onto a casting roll, then drawing the extruded blend to a desired sheet thickness while in the molten state.

In alternative embodiments the barrier layer may be prepared using a cast film process or a blown film process. Other film fabricating techniques suitable for making polymer films or layers may also be used (e.g., tenter frames).

In a blown film process, the HBP composition comprising a synergistic blend of nucleating agent and hydrocarbon resin dispersed within HDPE may be extruded through an annular die to form a cylindrical tube, which is then expanded to form a layer of desired thickness using internal air pressure inside the tube of molten polymer material.

Some suitable film extrusion techniques are also described in the technical guide titled ‘Film Extrusion and Conversion’, published by Qenos Pty Ltd (issued July 2015), the contents of which are incorporated herein by reference.

In some embodiments, a method of preparing thermoplastic compositions of the invention comprises the steps of:
(a) adding a high barrier polyolefin composition as described herein to an apparatus, the apparatus comprising a die and a mould, the mould having an interior surface defining a shape for a moulded article;
(b) melting the composition by heating, wherein the heating is sufficient to melt and extrude the composition through the die;
(c) forming a molten mass (also referred to as a parison) from the extruded composition;
(d) capturing the mass in the mould;
(e) inflating the extruded mass with pressurised fluid to produce a moulded article by conforming the mass to the interior surface of the mould;
(f) cooling the moulded article to at least partially solidify the composition; and
(g) obtaining the moulded article from the mould.

The above-mentioned composition may be any embodiment of the composition of the invention. Preferably, the apparatus is any suitable extrusion blow moulding apparatus, for example, continuous extrusion blow moulding apparatus, such as rotary wheel extrusion blow moulding apparatus and shuttle extrusion blow moulding apparatus, and intermittent extrusion blow moulding apparatus, such as reciprocating screw extrusion blow moulding apparatus and accumulator head extrusion blow moulding apparatus. Preferably, the apparatus includes a die through which the plasticised (molten) composition is extruded to form a parison. Preferably, the apparatus also includes a mould having a mould cavity. Preferably, the shape of the moulded article is defined by the mould cavity or the interior surfaces of the mould cavity. Preferably, the exterior surfaces of the moulded article is defined by the interior surfaces of the mould cavity.

In some embodiments, a method of producing a film from a thermoplastic composition of the invention comprises the steps of:
(a) adding a high barrier polyolefin composition as described herein to an apparatus, the apparatus comprising:
   a die having an annular die orifice adapted to extrude a tube;
   a means for blowing pressurised fluid into the tube exiting the annular die orifice; and
   a means for drawing and collecting the tube;
(b) melting the composition by heating, wherein the heating is sufficient to melt and extrude the composition through the die;
(c) forming a tube by extruding the molten composition through the annular die orifice exiting the annular die orifice in a first direction, the tube having a diameter and a length;
(d) inflating the tube by blowing a pressurised fluid into the tube to increase its diameter while simultaneously drawing the tube in the first direction to increase its length, to produce a film;
(e) cooling the film to solidify the composition; and
(f) obtaining the film.

In one or more embodiments, incorporation of the barrier layer in the film may reduce the water vapour transmission rate (WVTR) of the film by at least 10%, at least 20%, at least 40%, or at least 60%, over a comparative film of equivalent thickness that either does not have a barrier layer, or which has a barrier layer that is not prepared with a HBP composition as described herein (e.g., a barrier layer that does not comprise a nucleating agent and hydrocarbon resin substantially homogeneously dispersed within the barrier composition). Thus, the barrier layer according to the present invention enables a film exhibiting a greater reduction in WVTR to be obtained, when compared to the WVTR of a comparative film.

A comparative film as described herein may be a film that comprises or is composed of a barrier layer formed with the bulk HDPE resin alone, which has no nucleating agent or hydrocarbon resin contained or dispersed therein.

In one or more embodiments, incorporation of the barrier layer in the film may reduce the oxygen transmission rate (OTR) of the film by at least 10%, at least 20%, at least 30%, at least 40%, at least 50%, or at least 60%, over a comparative film of equivalent thickness that either does not have a barrier layer, or which has a barrier layer that is not prepared using a HBP composition as described herein (e.g., a barrier layer that does not comprise a synergistic combination of a nucleating agent and hydrocarbon resin substantially homogeneously dispersed within the barrier composition). Thus, the barrier layer according to the present invention enables a film exhibiting a greater reduction in OTR to be obtained, when compared to the OTR of a comparative film.

Thus, by blending bulk HDPE with a nucleating agent and hydrocarbon resin, via a polyolefin carrier, to form a HBP composition, through the use of masterbatch compositions in accordance with the embodiments disclosed herein, and forming a barrier layer from the HBP composition, the inventors surprisingly found that a reduction in W/TR may be achieved.

The effects observed are unexpected due to the relatively small quantities of hydrocarbon resin and nucleating agent employed. Without wishing to be limited by any theory, it is believed that hydrocarbon resin (preferably hydrogenated hydrocarbon resin) dispersed in a polyolefin, such as polyethylene, preferably HDPE, may assist in making the amorphous phase of the polyolefin less permeable to elements such as oxygen and water vapour whilst enhancing the dispersion of the crystalline phase within the polymer. In this manner, the hydrocarbon resin may thus augment the action of the nucleating agent in the polyolefin and thus help to reduce oxygen and/or water vapour permeation further, and beyond an additive or cumulative effect, i.e., to produce a ‘synergistic’ effect.

A further advantage of the present invention is that nucleating agent and hydrocarbon resin (preferably hydrogenated hydrocarbon resin) may be used with many different types of polyolefins, such as polyethylene, preferably HDPE, including those conventionally regarded as less responsive to nucleation. Thus, improved barrier properties can advantageously be imparted to a wider range of polyolefins, including but not limited to polyethylene and HDPE.

The improved films described herein have value in packaging applications where a low rate of water vapour transmission and/or oxygen transmission rate along with retaining good mechanical properties such puncture and tear resistance, can be desired to help increase the shelf life of packaged material. In turn, the improved barrier properties may enable the thickness of the barrier layer and films containing the barrier layer to be reduced, thereby saving cost, in addition to environmental advantages.

The invention will now be described with reference to the following examples. However, it is to be understood that the examples are provided by way of illustration of the invention and that they are in no way limiting to the scope of the invention.

### EXAMPLES

### Materials:

The following materials were used in the Examples described below:
HDPE(a)—Qenos Alkatane HD0195FX—high density polyethylene homopolymer: 1.4 MI₂, 45 MFR, density of 0.955 g/cm³
HDPE(b)—Qenos Alkatane HDF895—high density polyethylene homopolymer: 0.8 MI₂, 58 MFR, density of 0.962 g/cm³
HDPE(c)—Qenos Alkatane HDF995X—high density polyethylene homopolymer: 0.9 MI₂, 70 MFR, density of 0.965 g/cm³
HDPE(d)—Qenos Alkatane GF7660—high density polyethylene copolymer: 0.3 MI₂, 120 MFR, density of 0.959 g/cm³
HDPE(e)—Qenos Alkatane HD1090—high density polyethylene copolymer: 10 MI₂, density of 0.956 g/cm³
NA—Milliken Hyperform 20E—66.6% cyclohexanedicarboxylic acid, calcium salt (1:1) and 33.3% zinc stearate
HCR—Hydrogenated cycloaliphatic hydrocarbon resin: softening point 124° C., Mn 400, Mw 700

### Methods of Producing HDPE Compositions for Barrier Film Formation

### Method 1: C1 to C15

To a selected HDPE resin was added specified quantities of nucleating agent (NA) and hydrocarbon resin (HCR) additives as follows:
C1: none
C2: 1% HCR (using 33% HCR MB)
C3: 3% HCR (using 33% HCR MB)
C4: 0.1% NA (using 20% NA MB)
C5: none
C6: 0.1% NA (using 20% NA MB)
C7: none
C8: 1% HCR (using 50% HCR MB)
C9: 2% HCR (using 50% HCR MB)
C10: 0.1% NA (using 20% NA MB)
C11: none
C12: 0.1% NA (using 20% NA MB)
C13: 4% HCR (using 60% HCR MB)
C14: none
C15: 0.1% NA (using 20% NA MB)

The resulting composition was melt blended in a twin-screw extruder, and then blown for film formation.

### Method 2: S1, S2, S5, S6, S7 and S8

To a selected HDPE resin was added specified quantities of nucleating agent (NA) and hydrocarbon resin (HCR) additives as follows:
S1: 0.1% NA (using 20% NA MB)+1% HCR (using 33% HCR MB); NA MB and HCR MB used in a ratio of 1:7
S2: 0.1% NA (using 20% NA MB)+3% HCR (using 33% HCR MB); NA MB and HCR MB used in a ratio of 1:18
S5: 0.1% NA (using 20% NA MB)+1% HCR (using 33% HCR MB)
S6: 0.1% NA (using 20% NA MB)+2% HCR (using 33% HCR MB); NA MB and HCR MB used in a ratio of 2:25
S7: 0.1% NA (using 20% NA MB)+4% HCR (using 60% HCR MB); NA MB and HCR MB used in a ratio of 2:27
S8: 0.1% NA (using 20% NA MB)+4% HCR (using 60% HCR MB)

The resulting composition was melt blended in a twin-screw extruder, and then blown for film formation.

### Method 3: S3 and S4

The specified quantities of NA, HCR and HDPE were melt mixed on a twin-screw extruder to produce a HBP MB [2.5% NA+50% HCR+47.5% HDPE w/w of the HBP MB].

The HBP MB was mixed with bulk HDPE on a twin-screw extruder to produce the HBP composition.
S3: 0.05% NA+1% HCR (using 2% HBP MB)
S4: 0.1% NA+2% HCR (using 4% HBP MB)

The resulting composition was then blown for film formation.

The barrier layer compositions are summarised in Table 1.

### General Method for Film Formation:

Films were produced from the HDPE blends and comparative HDPE blends using a blown film extrusion process on a blown film line. A film containing bulk HDPE resin only (i.e., with no nucleating agent or hydrocarbon resin) was also prepared for comparison.

Using the blown film process, the HDPE was melted then extruded through an annular die vertically upwards to give a tube of controlled diameter and thickness. The extruded melt was air cooled in the vicinity of the die via a cooling ring and the tube of film inflated to a bubble of the required diameter by air introduced through the centre of the die mandrel. The film was hauled through a pair of nip rollers to contain a constant volume of inflation air within the bubble formed between the nip rollers and the die. The bubble was then collapsed in a collapsing frame and flattened through nip rollers to form a layflat film that can be wound up either as tubular film or slit into sheet film.

Films were formed by blown film extrusion using the following process parameters:
Film gauge: 40-50 μm
Blow up ratio (BUR): 2.5
Frost line height: 300 mm (low) or 800 mm (high)
Lay flat width: 40-45 cm
Zone temperatures: 190° C. max 20
Screw revolution: 300 rpm

### WVTR Testing:

The formed films were assessed for WVTR at a temperature of about 38° C. and at about 90% external relative humidity, in accordance with test method ASTM E398-20, using the Permatran-W Model 1/50 G by Mocon.

Improvement in WVTR (i.e., reduction in water vapour transmission) was determined assessing the difference in WVTR obtained for a film prepared with bulk HDPE resin only and a film formed with a HDPE blend. The improvement may be expressed as a change on WVTR (ΔWVTR) using the following equation:

$$Δ WVTR = \frac{WVTR ( HDPE only ) - WVTR ( sample )}{WVTR ( HDPE only )}$$

It can be seen from the above results that films formed from HBP compositions containing (i) 0.1% NA+1-3% HCR, using Method 2 (i.e., samples S1 and S2); and (ii) 0.05-0.1% NA+1-2% HCR, using Method 3 (i.e., S3 and S4) provided significantly improved barrier results balanced with good film mechanical properties over the comparison films.

### OTR Testing:

The formed films were assessed for OTR at a temperature of about 23° C. and at about 0% external relative humidity, in accordance with test method ASTM D3985-05, using the Ox-Tran 2/22 by Mocon.

Improvement in OTR (i.e., reduction in oxygen transmission) was determined assessing the difference in OTR obtained for a film prepared with bulk HDPE resin only and a film formed with a HDPE blend. The improvement may be expressed as a change on OTR (ΔOTR) using the following equation:

$$Δ OTR = \frac{OTR ( HDPE only ) - OTR ( sample )}{OTR ( HDPE only )}$$

TABLE 1
Barrier layer compositions and film properties

| | | | WVTR | | OTR | | |
|---|---|---|---|---|---|---|---|
| | | Film | Normalised | | Normalised | | MD Tear |
| | Barrier layer | thickness | to 40 μm | ΔWVTR | to 40 μm | ΔOTR | Strength |
| Sample | components | (μm) | (g/m²/day) | (%) | (cc/m²/day) | (%) | (mN) |
| C1: | comparison film | 45.5 | 3.39 | — | | | 289.5 |
| | containing HDPE(b) | | | | | | |
| | only | | | | | | |
| C2: | comparison film | 49.1 | 3.68 | −8.6 | | | 273.8 |
| | containing HDPE(b) + | | | | | | |
| | 1% HCR w/w | | | | | | |
| C3: | comparison film | 47.2 | 2.80 | 17.3 | | | 292.6 |
| | containing HDPE(b) + | | | | | | |
| | 3% HCR w/w | | | | | | |
| C4: | comparison film | 48.2 | 2.77 | 18.3 | | | 305.8 |
| | containing HDPE(b) + | | | | | | |
| | 0.1% NA w/w | | | | | | |
| C5: | comparison film | 43.3 | 3.10 | — | 1315 | | 301 |
| | containing HDPE(a) | | | | | | |
| | only | | | | | | |
| C6: | comparison film | 44.2 | 2.22 | 28.4 | 829 | 37.0 | 258 |
| | containing HDPE(a) + | | | | | | |
| | 0.1% NA w/w | | | | | | |
| C7: | comparison film | 51.3 | 3.2 | — | | | 262 |
| | containing HDPE(c) | | | | | | |
| | only | | | | | | |
| C8: | comparison film | 52.83 | 3.0 | 6.3 | | | 265 |
| | containing HDPE(c) + | | | | | | |
| | 1% HCR w/w | | | | | | |
| C9: | comparison film | 51.3 | 3.0 | 6.3 | | | 271 |
| | containing HDPE(c) + | | | | | | |
| | 2% HCR w/w | | | | | | |
| C10: | comparison film | 49.1 | 2.5 | 21.9 | | | 229 |
| | containing HDPE(c) + | | | | | | |
| | 0.1% NA w/w | | | | | | |
| C11: | comparison film | 36.3 | 4.54 | — | | | |
| | containing HDPE(d) | | | | | | |
| | only | | | | | | |
| C12: | comparison film | 40.6 | 3.98 | 12.3 | | | |
| | containing HDPE(d) + | | | | | | |
| | 0.1% NA w/w | | | | | | |
| C13: | comparison film | 42.6 | 3.43 | 24.4 | | | |
| | containing HDPE(d) + | | | | | | |
| | 4% HCR w/w | | | | | | |
| C14: | comparison plaque | 925 | 3.89 | — | 1489 | — | |
| | containing HDPE(e) | | | | | | |
| | only | | | | | | |
| C15: | comparison plaque | 920 | 2.46 | 36.8 | 943 | 36.9 | |
| | containing HDPE(e) + | | | | | | |
| | 0.1% NA w/w | | | | | | |
| S1: | film of the invention | 46.8 | 1.68 | 50.4 | | | 287.9 |
| | containing HDPE(b) + | | | | | | |
| | 0.1% NA w/w + | | | | | | |
| | 1% HCR w/w | | | | | | |
| S2: | film of the invention | 47.3 | 1.46 | 56.9 | 500 | 62 | 288.7 |
| | containing HDPE(b) + | | | | | | |
| | 0.1% NA w/w + | | | | | | |
| | 3% HCR w/w | | | | | | |
| S3: | film of the invention | 50.4 | 1.49 | 51.9 | 718 | 45.4 | 281.3 |
| | containing HDPE(a) + | | | | | | |
| | 0.05% NA w/w + | | | | | | |
| | 1% HCR w/W | | | | | | |
| S4: | film of the invention | 43.2 | 1.38 | 55.5 | 650 | 50.6 | 267 |
| | containing HDPE(a) + | | | | | | |
| | 0.1% NA w/w + | | | | | | |
| | 2% HCR w/W | | | | | | |
| S5: | film of the invention | 50.4 | 1.6 | 50.0 | | | 227 |
| | containing HDPE(c) + | | | | | | |
| | 0.1% NA w/w + | | | | | | |
| | 1% HCR w/w | | | | | | |
| S6: | film of the invention | 48.9 | 1.5 | 53.1 | | | 219 |
| | containing HDPE(c) + | | | | | | |
| | 0.1% NA w/w + | | | | | | |
| | 2% HCR w/w | | | | | | |
| S7: | film of the invention | 41.8 | 2.466 | 45.8 | | | |
| | containing HDPE(d) + | | | | | | |
| | 0.1% NA w/w + | | | | | | |
| | 4% HCR w/W | | | | | | |
| S8: | plaque of the | 940 | 2.21 | 43.2 | 745 | 50.0 | |
| | invention containing | | | | | | |
| | HDPE(e) + 0.1% NA | | | | | | |
| | w/w + 4% HCR w/w | | | | | | |

The examples provided herein show that one or more embodiments of barrier layers and films of the invention may provide useful alternatives to barrier layers and films known in the art, or, particularly in preferred embodiments, one or more advantages, such as, for example, one or more of the following:
improved balance of mechanical properties, such as stiffness, or puncture and tear resistance;
lowered cost of production, for example, due to relatively low levels of hydrocarbon resin used;
improved processability;
improving the homogenous dispersion of the nucleating agent or hydrocarbon resin;
providing a synergistic combination of the nucleating agent and hydrocarbon resin;
improving the crystalline characteristics of the resultant barrier layer;
facilitating the effectiveness of the compounding, melt-mixing and/or extrusion processes;
enabling the addition of small or precise quantities of nucleating agent and/or hydrocarbon resin to bulk HDPE;
improved barrier film properties, such as lower WVTR or OTR; and
enabling reduced thickness of the barrier layer or film, while retaining one or more of the above properties.

For the avoidance of doubt, any reference to or discussion of any document, act or item of knowledge in this specification is included solely for the purpose of providing a context for the present invention. It is not suggested or represented that any of these matters or any combination thereof formed at the priority date part of the common general knowledge, or was known to be relevant to an attempt to solve any problem with which this specification is concerned.

It is to be understood that various other modifications and/or alterations may be made without departing from the spirit of the present invention as outlined herein.

1. A high barrier polyolefin composition comprising:
a nucleating agent in an amount of from 0.01% w/w to 1% w/w;
a hydrocarbon resin in an amount of from 0.1% w/w to 5% w/w,
optionally one or more additive components, and
a polyethylene.

2. The high barrier polyolefin composition of claim 1 comprising a hydrocarbon resin in an amount of from 0.5% w/w to 5% w/w.

3. The high barrier polyolefin composition of claim 1, wherein the polyethylene is HDPE.

4. The high barrier polyolefin composition of claim 1, wherein the polyethylene is present in an amount not less than 90% w/w.

5. The high barrier polyolefin composition of claim 1, wherein the nucleating agent and hydrocarbon resin in the composition are uniformly dispersed.

6. A masterbatch comprising a nucleating agent, a hydrocarbon resin and a polyethylene, wherein:
the nucleating agent is present in the masterbatch in an amount of from about 0.2% w/w to about 15% w/w;
the hydrocarbon resin is present in the masterbatch in an amount of from about 2.5% w/w to about 80% w/w; and
the polyethylene is present in the masterbatch in an amount greater than about 5% w/w,
when used to form a high barrier polyolefin composition comprising:
the nucleating agent in an amount of from about 0.01% w/w to about 1% w/w; and
the hydrocarbon resin in an amount of from about 0.1% w/w to about 7% w/w.

7. A masterbatch comprising a nucleating agent, a hydrocarbon resin and a polyethylene, wherein:
the nucleating agent is present in the masterbatch in an amount of from 0.2% w/w to about 15% w/w;
the hydrocarbon resin is present in the masterbatch in an amount of from about 25% w/w to about 55% w/w; and
the polyethylene is present in the masterbatch in an amount greater than about 20% w/w.

8. A kit comprising a nucleating agent masterbatch and a hydrocarbon resin masterbatch, wherein:
the nucleating agent is present in the nucleating agent masterbatch in an amount of from about 0.1% w/w to about 30% w/w; and
the hydrocarbon resin is present in the hydrocarbon resin masterbatch in an amount of from about 5% w/w to about 80% w/w,
when used to form a high barrier polyolefin composition comprising:
the nucleating agent in an amount of from 0.01% w/w to 1% w/w; and
the hydrocarbon resin in an amount of from 0.1% w/w to 5% w/w,
wherein the nucleating agent masterbatch and the hydrocarbon resin masterbatch are used in a ratio of about 5:1 to about 1:60.

9. A kit comprising a nucleating agent mixture and a hydrocarbon resin masterbatch, wherein:
the nucleating agent mixture comprises a nucleating agent and a polyolefin; and
the hydrocarbon resin is present in the hydrocarbon resin masterbatch in an amount of from about 5% w/w to about 80% w/w,
when used to form a high barrier polyolefin composition comprising:
the nucleating agent in an amount of from 0.01% w/w to 1% w/w; and
the hydrocarbon resin in an amount of from 0.1% w/w to 5% w/w.

10. The kit of claim 8, wherein the high barrier polyolefin composition comprises the hydrocarbon resin in an amount of from 0.5% w/w to 5% w/w.

11. The kit of claim 8, wherein the high barrier polyolefin composition comprises polyethylene in an amount not less than 90% w/w.

12. The high barrier polyolefin composition of claim 1, wherein the nucleating agent and hydrocarbon resin are present in a ratio of about 1:4 to about 1:200.

13. The high barrier polyolefin composition of claim 1, wherein the hydrocarbon resin is derived from crude olefin feed selected from the group consisting of C5 olefin feed streams, C9 olefin feed streams, terpene olefins, norbornene, pure monomers, and a combination thereof.

14. The high barrier polyolefin composition of claim 1, wherein the nucleating agent comprises a metal salt.

15. The high barrier polyolefin composition of claim 1, wherein the nucleating agent comprises a hydrophthalic acid metal salt, a bicycloheptane dicarboxylic acid metal salt, or a combination thereof.

16. The high barrier polyolefin composition of claim 1, wherein the nucleating agent comprises a hydrophthalic acid metal salt.

17. The high barrier polyolefin composition of claim 1, wherein the nucleating agent comprises a hexahydrophthalic acid metal salt.

18. The masterbatch of claim 7, wherein the polyethylene is HDPE.

19. Use of the masterbatch of claim 7 to form a high barrier polyolefin composition, wherein the ratio of the nucleating agent to hydrocarbon resin in the high barrier polyolefin composition is the same as the ratio of nucleating agent to hydrocarbon resin in the masterbatch.

20. The masterbatch of claim 6, wherein the nucleating agent and hydrocarbon resin in the high barrier polyolefin composition are uniformly dispersed.

21. A barrier layer formed from:
the high barrier polyolefin composition of claim 1.

22. A film comprising the barrier layer of claim 21, wherein the film has a water vapour transmission rate, as measured by ASTM F 1249-20, which is reduced by at least about 10% relative to an equivalent film which does not comprise the barrier layer of claim 21.

23. A method of reducing the water vapour transmission rate of a film, the method comprising incorporating the barrier layer of claim 21 into the film, wherein the film has a water vapour transmission rate, as measured by ASTM F 1249-20, which is reduced by at least about 10% relative to an equivalent film which does not comprise the barrier layer of claim 21.

24. A blown moulded article comprising the film of claim 22.

25. An injection moulded article comprising the film of claim 22.
